(19) United States
(12) Patent Application Publication
(10) Pub. No.: US 2024/0430799 A1
(43) Pub. Date: Dec. 26, 2024

(54) ADVERTISING FOR BATTERYLESS TAGS USING PERIODIC ADVERTISEMENT

(71) Applicant: QUALCOMM Incorporated, San Diego, CA (US)

(72) Inventors: Nicolas GRAUBE, Cambridge (GB); Tingting LIU, Cambridge (GB); Chengjin ZHANG, San Diego, CA (US)

(21) Appl. No.: 18/666,463

(22) Filed: May 16, 2024

Related U.S. Application Data
(60) Provisional application No. 63/509,245, filed on Jun. 20, 2023.

(51) Int. Cl. H04W 52/02; H04W 56/00

(52) U.S. Cl. CPC H04W 52/0216; H04W 56/001

(57) ABSTRACT

Disclosed are systems, apparatuses, processes, and computer-readable media for wireless communications. For example, a wireless communication device can receive an energizing signal from an energizer and can harvest energy from the energizing signal. The wireless communication device can synchronize, based on one of the energizing signal or a beacon signal, timing for a timing schedule associated with the wireless communication device. The wireless communication device can transmit a signal according to the timing schedule associated with the wireless communication device.

### CROSS-REFERENCE TO RELATED APPLICATION

This application claims the benefit of, and priority to, U.S. Provisional Application No. 63/509,245, filed Jun. 20, 2023, which is hereby incorporated by reference, in its entirety and for all purposes.

### FIELD OF THE DISCLOSURE

The present disclosure generally relates to wireless communications. For example, aspects of the present disclosure relate to systems and techniques for providing a secure method for advertising for batteryless wireless communication devices using a periodic advertisement (PA).

### BACKGROUND OF THE DISCLOSURE

Short range wireless communication enables wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHz.

BLUETOOTH® Low Energy (BLE) is a form of BLUETOOTH® communication that allows for communication with devices running on low power. Such devices may include beacons, which are wireless communication devices that may use low-energy communication technology for positioning, proximity marketing, or other purposes. In some cases, such devices may serve as nodes (e.g., relay nodes) of a wireless mesh network that communicates and/or relays information to a managing platform or hub associated with the wireless mesh network.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for wireless communications. According to at least one illustrative example, a wireless communication device is provided. The wireless communication device includes at least one processor configured to: receive an energizing signal from an energizer; harvest energy from the energizing signal; synchronize, based on one of the energizing signal or a beacon signal, timing for a timing schedule associated with the wireless communication device; and cause a signal to be transmitted according to the timing schedule associated with the wireless communication device.

In another illustrative example, a method of wireless communication performed at a wireless communication device is provided. The method includes: receiving, by the wireless communication device, an energizing signal from an energizer; harvesting, by the wireless communication device, energy from the energizing signal; synchronizing, by the wireless communication device based on one of the energizing signal or a beacon signal, timing for a timing schedule associated with the wireless communication device; and transmitting, by the wireless communication device, a signal according to the timing schedule associated with the wireless communication device.

In another illustrative example, a non-transitory computer-readable storage medium of a wireless communication device is provided that includes instructions stored thereon which, when executed by at least one processor, cause the at least one processor to: receive an energizing signal from an energizer; harvest energy from the energizing signal; synchronize, based on one of the energizing signal or a beacon signal, timing for a timing schedule associated with the wireless communication device; and cause a signal to be transmitted according to the timing schedule associated with the wireless communication device.

In another illustrative example, a wireless communication device is provided. The wireless communication device includes: means for receiving an energizing signal from an energizer; means for harvesting energy from the energizing signal; means for synchronizing, based on one of the energizing signal or a beacon signal, timing for a timing schedule associated with the wireless communication device; and means for transmitting a signal according to the timing schedule associated with the wireless communication device.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which systems and/or methods described herein may be implemented, in accordance with some aspects of the present disclosure.

FIG. 2 is a diagram illustrating example components of a device, in accordance with some aspects of the present disclosure.

FIG. 3 is a signaling diagram illustrating example communication transmissions, in accordance with some aspects of the present disclosure.

FIG. 4 is a signaling diagram illustrating an example of communication transmissions between a network device and two groups of wireless communication devices, in accordance with some aspects of the present disclosure.

FIG. 5 is a diagram illustrating an example of a radio frequency (RF) energy harvesting device, in accordance with some aspects of the present disclosure.

FIG. 6 is a diagram illustrating an example associated with discovery and synchronization between access points, in accordance with some aspects of the present disclosure.

FIG. 7 is a diagram illustrating an example of a system for batteryless wireless communication devices (e.g., labels or tags) advertising using a periodic advertisement, in accordance with some aspects of the present disclosure.

FIG. 8 is a simplified diagram illustrating an example of signaling for batteryless wireless communication devices advertising using a periodic advertisement, where energy bursts provide a time base as a basis for a virtual periodic advertisement (PA) to allow batteryless wireless communication devices to transmit on a data channel, in accordance with some aspects of the present disclosure.

FIG. 9 is a diagram illustrating an example of signaling for batteryless wireless communication devices advertising using a periodic advertisement, where energy bursts indicate a schedule (e.g., transmit slots) for transmission by the batteryless wireless communication devices, in accordance with some aspects of the present disclosure.

FIG. 10 is a diagram illustrating an example of signaling for batteryless wireless communication devices advertising using a periodic advertisement, where a periodic advertisement (PA) indicates a schedule (e.g., response slots) for transmission by the batteryless wireless communication devices, in accordance with some aspects of the present disclosure.

FIG. 11 is a flow chart illustrating an example of a process for wireless communications, in accordance with some aspects of the present disclosure.

FIG. 12 is a block diagram illustrating an example of a computing system, which may be employed by the disclosed systems and techniques for batteryless wireless communication devices advertising using a periodic advertisement, in accordance with some aspects of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

A system may include one or more wireless communication devices that are controlled by a network entity. For example, a system including multiple peripheral devices (e.g., an electronic shelf label (ESL) system) may include one or more wireless communication devices (e.g., peripheral devices, such as ESLs) that are controlled by a network entity, such as a management entity (ME), via at least one additional network entity, such as an access point (AP). As used herein, the terms “network entity” and “network device” may be interchangeable. For example, an AP can be referred to as an example of a “network entity” and/or can be referred to as an example of a “network device.” A “network entity” can include an AP, an ME, and/or a combination of the two. A “network device” can include an AP, an ME, and/or a combination of the two. In some examples, a single device can implement the functionality of an ME and an AP (e.g., an ME and an AP can be combined in a single device).

In one or more examples, to facilitate control by an ME, each peripheral device (e.g., ESL) may have a wireless connection (e.g., a BLUETOOTH® Low Energy (BLE) connection or other connection) to an AP that is communicatively connected to the ME (e.g., via the Internet, such as wirelessly, via an Ethernet connection, etc.). In some cases, commands from the ME may be wirelessly transmitted to the peripheral devices (e.g., ESLs) by the AP. Responses or information from the peripheral devices may also be received by the AP, and provided by the AP to the ME.

Each AP may have an associated channel map. A channel map is a listing of frequency channels to be utilized or, conversely, not to be utilized (e.g., in the context of modification of hopping frequency sequences) by an AP for communication, such as with the ESLs or other peripheral devices. While examples are described herein using ESLs as illustrative examples of wireless communication devices, a management entity as an example of a network entity, and access points as examples of network entities, the systems and techniques described herein are applicable to any type of system or network.

In ESL systems, periodic Advertisements (PAs) can be utilized to provide regular and predictable payload transmissions from a central device (e.g., which may be in the form of a network device, such as an AP) to one or more peripheral devices (e.g., which may each be in the form of a wireless communication device, such as an ESL or other peripheral device). For example, PAs can be used to issue information from a central device to multiple peripheral devices, which may be within one or more groups of peripheral devices. PAs are generally unidirectional (e.g., unidirectional transmissions) such that PAs are transmitted only one-way from a central device to one or more peripheral devices.

Periodic Advertisement with Response (PAwR) can be used for ESL systems to provide bidirectionality (e.g., bidirectional transmissions between a central device and one or more peripheral devices). Peripheral devices synchronized within a group of peripheral devices can be addressed by a central device on a synchronized channel (e.g., a radio frequency (RF) channel between the central device and the peripheral devices) whenever the central device determines to send (e.g., transmit) a request to the peripheral devices. In some cases, as used herein, a synchronized channel refers to a channel on which transmissions are synchronized (in time). For example, the channel can utilize or can be based on a frequency on which one or more communications are transmitted. A hopping frequency sequence (HFS) can be associated with the channel. In some cases, the HFS may progress at a fixed and/or pre-determined interval. In some cases, a channel map may change, such as if interference on one or more channels changes, in which case the HFS can be updated (there may not be a fixed interval). In such cases, a minimum time between updates of an HFS can be applied, which can avoid updating the HFS too frequently. A central device and one or more peripheral devices can concurrently track the sequence at a predefined frequency hopping pattern or sequence (e.g., such that the central device knows when to transmit the request and the peripheral devices know when to listen for and/or receive the request).

A request transmitted by a central device to peripheral devices in a particular group may be a PA containing a synchronization message transmitted by the central device on the synchronized channel to the peripheral devices of the particular group. For example, wireless communication devices within a particular group can wake up (e.g., from a low power (LP) mode) at the same PA transmission with respect to a particular PAwR train for that group. A PA is made up of a periodic set of transmissions, where the collection of transmissions is collectively referred to as a PA train or a PAwR train when applied to PAwR. Each transmission of a PA train (or PAwR train) occurs at a precise point in time, with fixed intervals between the transmissions. A communication channel (e.g., one communication channel out of thirty-seven available communication channels) is selected for each of the transmissions, where the communication channel follows a hopping frequency sequence. The synchronization between the central device and the peripheral devices in the group is based on the periodicity of the PA. The periodically-transmitted messages (e.g., the synchronization messages) can include zero, one, or more commands (e.g., including a respective operational code (OpCode) and parameters associated with each command). If a response from a peripheral device is expected by the central device (e.g., the synchronization message from the central device requests a response from a specific peripheral device), the particular peripheral device will respond in a specific response slot, based on where the peripheral device appeared within a sequence contained within the synchronization message transmitted by the central device.

In some cases, an ESL may be physically moved to a new location. For example, the ESL may be moved from one location in a retail store (e.g., a particular shelf or a storage area) to a different location. Changing the location of the ESL may result in the ESL losing synchronization with (e.g., due to being out of communication range) a current access point for which the ESL is associated. Such a loss in synchronization may interrupt a management entity's ability to control the ESL and the ESL's ability to report to the management entity. After determining a network outage (e.g., caused by the loss of synchronization), the ESL may perform an onboarding procedure to reestablish synchronization with an access point.

To perform the onboarding procedure, the ESL may transmit advertisement messages (e.g., a connectable advertisement (CAP)), receive a connection request from an in-range access point (e.g., an access point that is within communication range) that detected the advertisement messages, and exchange messages with the access point (e.g., including the exchange of periodic advertisement synchronization transfer (PAST) information). The onboarding procedure may consume significant computing resources (e.g., processor resources, memory resources, and/or battery resources, among other examples) of the ESL and/or the access point, and frequent advertisements by one or more ESLs can result in spectral pollution on advertisement channels of the wireless network.

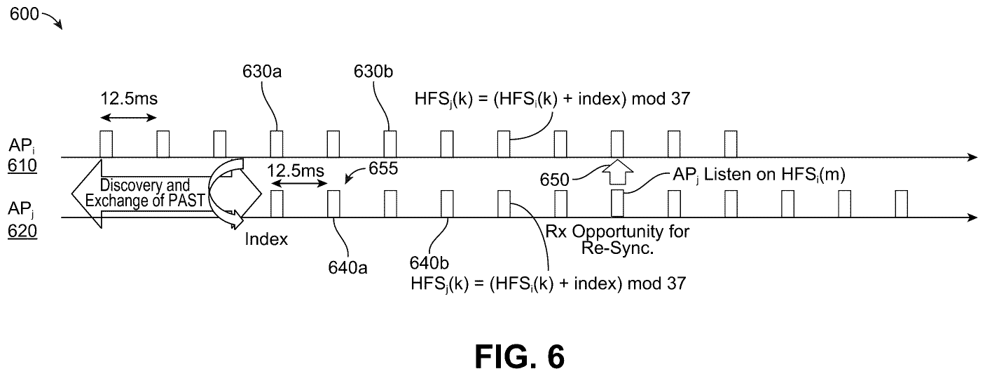

Access point synchronization (e.g., described in detail in the description of FIG. 6) can enable discovery and synchronization of communication timings of multiple access points within an ESL system. In particular, periodic advertisement timings used by the multiple access points may be synchronized. In access point synchronization, an ESL can have access to multiple access points. When an ESL is moved from one location to another location such that the ESL is out of communication range of its current associated access point, the ESL can identify an alternative access point that is within communication range of the ESL to associate with and jump on a periodic advertisement with multiple responses (PAwMR) train associated with that access point.

Currently, RF energy harvesting (RFEH) is a growing technology and has become useful for applications in retail environments, especially in applications linked to ESL systems. Some RFEH devices (e.g., wireless communication devices in the form of batteryless tags or labels) can use BLE signals as an information bearer (e.g., a carrier of the information). RFEH devices, after having accumulated a sufficient amount of energy for transmission, can issue (transmit) a simple BLE beacon signal (e.g., on a BLE advertisement channel, such as BLE channels 37, 38, and 39). The beacon signals can be used for tracking assets associated with the RFEH devices. Each beacon signal can contain an identification (ID) and/or other information or characteristic (e.g., unique information or characteristic) associated with its respective RFEH device and, optionally, sensor data (e.g., temperature, humidity, etc.) obtained by one or more sensors implemented in its associated RFEH device. However, congestion on the BLE advertisement channels (e.g., BLE channels 37, 38, and 39) can make a successful issuing (transmission) of a beacon signal from these RFEH devices (e.g., ESLs) challenging. BLE protocol compliant alternatives to using these BLE advertisement channels (e.g., channels 37, 38, and 39) should be provided to increase the probability of detection of these beacon signals.

A limited energy harvesting budget can result in a limited amount of available power for transmission by the RFEH devices (e.g., wireless communication devices in the form of batteryless tags or labels). Traditional non-connectable advertisements transmitted (e.g., on the BLE advertisement channels) from BLE devices can compete with all other BLE systems. Interference on the BLE advertisement channels (e.g., BLE channels 37, 38, and 39) is typically very high in retail deployment scenarios (e.g., where competition of signals within a visible light communication system can lead to a fallback system that employs a dense usage of beacon signals). As such, weak signals (e.g., transmissions from RFEH devices), which are transmitted on these BLE advertisement channels, can be swamped (e.g., interfered with) by many other beacon signals (beacons).

The RFEH devices (e.g., wireless communication devices in the form of batteryless tags or labels) can collect energy from RF signals via the use of a rectifier, a power management integrated circuit (PMIC), and a capacitor within the RFEH devices. The energy source (e.g., a device transmitting the RF signals, such as an energizer) is not necessarily linked or common to the BLE 2.4 Gigahertz (GHz) frequency. RFEH devices operate using an internal oscillator (OSC), which is low cost and low power. The local OSC of the RFEH devices needs to be tuned to the transmission (Tx) frequency for the RFEH devices. The RFEH devices can use a preamble of a beacon signal (e.g., transmitted on a BLE advertisement channel) to tune their local oscillators (OSCs) to the transmission frequency. There is a need for an effective beacon (e.g., for OSC tuning) as an alternative to an advertisement channel, in a way which is compatible with the BLE protocol and that does not require communication exchange with tags ahead of beacon transmission.

In one or more aspects of the present disclosure, systems, apparatuses, methods (also referred to as processes), and computer-readable media (collectively referred to herein as “systems and techniques”) are described herein that provide solutions for wireless communication devices (e.g., RFEH devices in the form of batteryless tags or labels) to transmit signals (e.g., beacon signals) successfully with a reduced amount of interference. In some aspects, systems and techniques are provided for wireless communication devices (e.g., RFEH devices in the form of batteryless tags or labels) advertising using a periodic advertisement (PA). In one or more aspects, the systems and techniques employ, for the transmissions of signals (e.g., beacon signals) by the wireless communication devices, BLE data channels (e.g., BLE channels 0 through 36), which are less crowded (and, as such, have less interference) than the BLE advertisement channels (e.g., BLE channels 37, 38, and 39). In some aspects, the timing of the transmitting and receiving of the wireless communication devices (e.g., RFEH devices in the form of batteryless tags or labels) can be synchronized by using energy burst boundaries or by using an ESL-energy (ESL-c) beacon signal. For example, the energy bursts provide a time source, which can be used as a prerequisite for a virtual PA and for wireless communication devices (e.g., RFEH devices) to take a role as a central device (also referred to herein as a “central” for the virtual PA).

In one or more examples, a first example solution involves the use of energy burst boundaries, where one or more wireless communication devices (e.g., RFEH devices in the form of a batteryless tags or labels) can each operate as a central and send its beacon signal at a particular time interval, which can be specified by energy burst boundaries.

In some examples, a second example solution involves the use of PAwR, where a network device (e.g., a scanner in the form of an access point) can operate as a central device and send a PA. The PAwR also has a quality of being beaconed on a given data channel that is deterministic without further data exchange towards the wireless communication device(s). For the second example solution, one or more wireless communication devices (e.g., RFEH devices in the form of batteryless tags or labels) can each send its beacon signal (e.g., as a response to the PA) at a specific channel (e.g., a BLE data channel) and time interval, which can be specified by the PA. For example, from the point of view of a wireless communication device (e.g., an RFEH device, such as a batteryless tag or label), there can be at least two cases. In a first case, the wireless communication device (e.g., the RFEH device) can receive enough energy to scan for a PAwR beacon from a network device, which will perform the scanning for the beacon from the wireless communication device (and in some cases other wireless communication devices) as a PAwR response. In a second case, wireless communication devices (e.g., RFEH devices) can act similarly or the same as that described above with respect to the first example solution, such as sending a beacon(s) in a predefined data channel and time slot as PA central devices, where the network device can schedule their PAwR request sending and response scanning at the same predefined channel and slot.

Additional aspects of the present disclosure are described in more detail below.

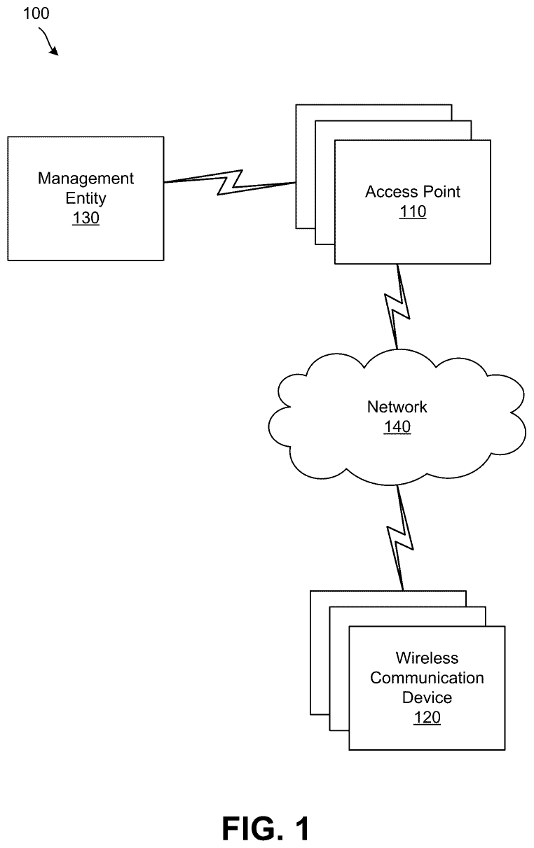

FIG. 1 is a diagram of an example environment 100 in which systems and/or methods described herein may be implemented. As shown in FIG. 1, the environment 100 may include at least one access point (AP) 110, at least one wireless communication device 120, a management entity (ME) 130, and a network 140. Devices of the environment 100 may interconnect via wired connections, wireless connections, or a combination of wired and wireless connections.

The access point 110 may include one or more devices capable of receiving, generating, storing, processing, providing, and/or routing information associated with access point synchronization and/or handover, as described elsewhere herein. The access point 110 may include a communication device and/or a computing device. The access point 110 may be configured to transmit beacons (e.g., BLE beacons), as well as to scan and locate other devices (e.g., other devices communicating using BLE protocols).

The wireless communication device 120 may include one or more devices capable of receiving, generating, storing, processing, and/or providing information associated with access point synchronization and/or handover, as described elsewhere herein. The wireless communication device 120 may include a communication device and/or a computing device. In some aspects, the wireless communication device 120 may be, may include, or may be included in an electronic shelf label (ESL).

The management entity 130 includes one or more devices capable of receiving, generating, storing, processing, providing, and/or routing information associated with access point synchronization and/or handover, as described elsewhere herein. The management entity 130 may include a communication device and/or a computing device. For example, the management entity 130 may include a server, such as an application server, a client server, a web server, a database server, a host server, a proxy server, a virtual server (e.g., executing on computing hardware), or a server in a cloud computing system. In some aspects, the management entity 130 includes computing hardware used in a cloud computing environment. The management entity 130 may provide control of a system (e.g., an ESL system) that includes the access point(s) 110, the wireless communication device(s) 120, and/or other device(s). The access point(s) 110 may be communicatively connected to the management entity 130 via a network (not shown), such as the Internet.

The network 140 may include one or more wireless networks. For example, the network 140 may include a personal area network (e.g., a Bluetooth network). The network 140 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

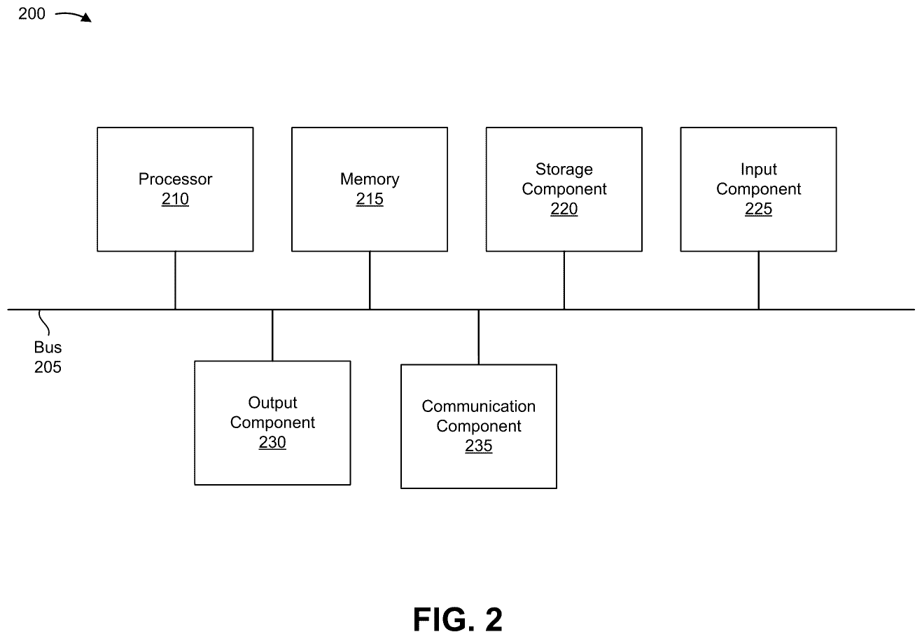

FIG. 2 is a diagram illustrating example components of a device 200, in accordance with the present disclosure. Device 200 may correspond to access point 110, wireless communication device 120, and/or management entity 130. In some aspects, access point 110, wireless communication device 120, and/or management entity 130 may include one or more devices 200 and/or one or more components of device 200. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

As previously mentioned, in ESL systems, PAs are often utilized to provide regular and predictable payload transmissions from a central device (e.g., which may be in the form of a network device, such as an access point) to one or more peripheral devices (e.g., which may each be in the form of a wireless communication device, such as an ESL). PAs can be used to issue information from a central device to multiple peripheral devices, which may be within one or more groups of peripheral devices. PAs are generally unidirectional (e.g., unidirectional transmissions) such that PAs are transmitted only one-way from a central device to one or more peripheral devices.

Periodic Advertisement with Response (PAwR) was introduced to ESL systems to provide bidirectionality (e.g., bidirectional transmissions between a central device and one or more peripheral devices). Peripheral devices synchronized within a group of peripheral devices can be addressed by a central device on a synchronized channel (e.g., a synchronized frequency channel between the central device and the peripheral devices) whenever the central device determines to send (e.g., transmit) a request (e.g., a PA containing a synchronization message transmitted on the synchronized channel) to the peripheral devices. If a response from a peripheral device is expected by the central device (e.g., the synchronization message from the central device requests a response from a specific peripheral device), the particular peripheral device will respond in a specific response slot, based on where the peripheral device appeared within a sequence contained within the synchronization message transmitted by the central device.

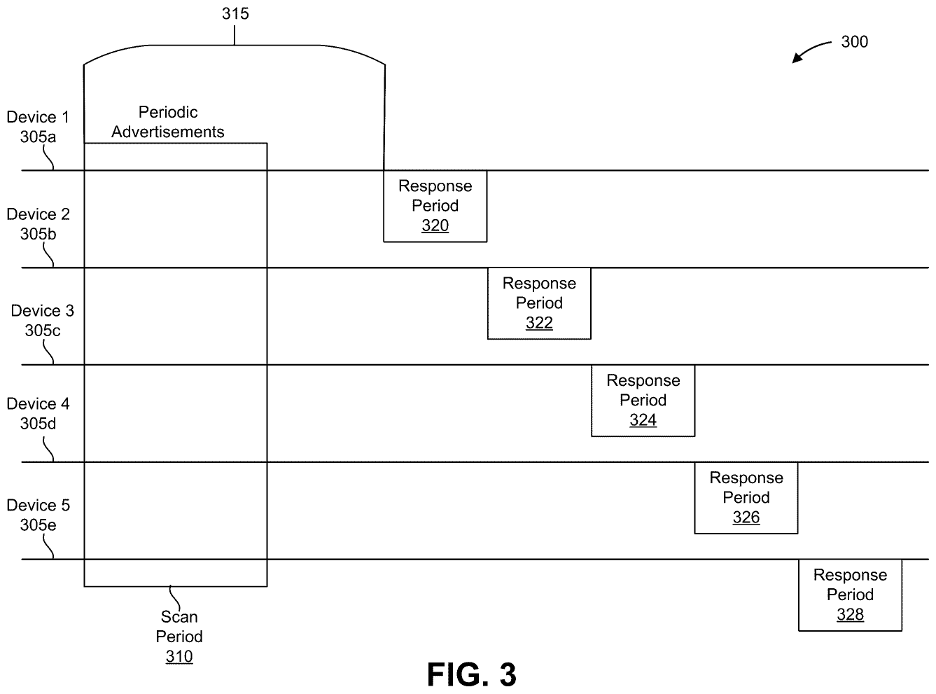

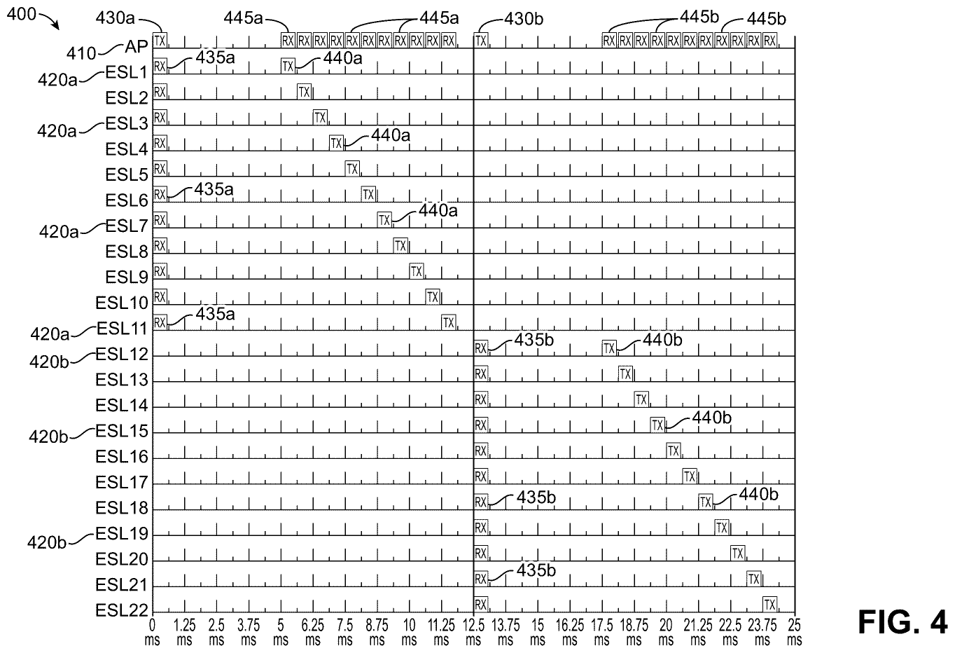

FIGS. 3 and 4 show signaling diagrams illustrating examples of PAwR in an ESL system. In particular, the signaling diagram of FIG. 3 shows an example PAR for a group of wireless network devices (e.g., device 1 305a, device 2 305b, device 3 305c, device 4 305d, and device 5 305c), and the signaling diagram of FIG. 4 shows an example PAwR for two groups of wireless network devices 420a, 420b (e.g., a first group including ESL 1 to ESL 11, and a second group including ESL 12 to ESL 22). Specifically, FIG. 3 is a signal timing diagram illustrating a portion of a communication between an access point (e.g., access point 110) and wireless communication devices 120 (e.g., ESLs). With reference to FIG. 1, the signal sequence illustrated in FIG. 3 may be implemented by one or more of the communication connections, access points 110, and/or wireless communication devices 120 of FIG. 1.

The devices (e.g., device 1 305a, device 2 305b, device 3 305c, device 4 305d, and device 5 305e) of FIG. 3 may be selected from wireless communication devices 120 of FIG. 1, and may each receive a periodic advertisement (PA) in a scan period 310. The scan period 310 may occur in regularly scheduled intervals and may be repeated periodically such that the devices (e.g., device 1 305a, device 2 305b, device 3 305c, device 4 305d, and device 5 305e) can awaken to scan for messages during this repeated scan period 310. An access point (e.g., access point 110 of FIG. 1) may provide periodic advertisements (PAS) via broadcast or multi-cast to the devices (e.g., device 1 305a, device 2 305b, device 3 305c, device 4 305d, and device 5 305e) in the scan period 310. For an access point (e.g., access point 110 of FIG. 1), the scan period 310 can be its primary transmission period. In some cases, the scan period 310 may not be a fixed time because the access point (e.g., access point 110 of FIG. 1) may send different lengths of data from the start of the scan period 310.

The transmission may include multiple advertisements in a train. One or more portions of the advertisements may be directed to one or more of the devices (e.g., device 1 305a, device 2 305b, device 3 305c, device 4 305d, and device 5 305e). The devices (e.g., device 1 305a, device 2 305b, device 3 305c, device 4 305d, and device 5 305e) may decode or filter the messages intended for each specific device and transmitted during the period when all devices are receiving. In this way, the devices (e.g., device 1 305a, device 2 305b, device 3 305c, device 4 305d, and device 5 305e) may be reprogrammed, updated, and/or sent requests from an access point (e.g., access point 110 of FIG. 1) or relayed from another device (e.g., management entity 130 of FIG. 1) through the access point (e.g., access point 110 of FIG. 1). The periodic advertisement (PA) from the access point (e.g., access point 110 of FIG. 1) may set a response period for one or more of the devices (e.g., device 1 305a, device 2 305b, device 3 305c, device 4 305d, and device 5 305e).

As illustrated, the devices (e.g., device 1 305a, device 2 305b, device 3 305c, device 4 305d, and device 5 305e) are each assigned a response period 320, 322, 324, 326, 328 in the time after the scan period 310. In some cases, the assignment of the response period to a particular device may not be permanent. In some aspects, the assignment may be inferred from a payload of a synchronization message. The first response period 320 may begin following an idle time 315 after the scan period 310, with the idle period being long enough to provide the transmitter device an opportunity to do other Bluetooth related activities. The assigned response periods may also be limited to or designate a particular frequency of the channels on which to respond. For example, in FIG. 3, device 1 305a is assigned response period 320, device 2 305b is assigned response period 322, device 3 305c is assigned response period 324, device 4 305d is assigned response period 326, and device 5 305e is assigned response period 328. The access point (e.g., access point 110 of FIG. 1) may store attributes of the devices (e.g., device 1 305a, device 2 305b, device 3 305c, device 4 305d, and device 5 305c), including whether a device is able to transmit or respond. The PA signaling followed by responses can be referred to as periodic advertisement with multiple responses (PAwMR).

For example, device 3 305c (e.g., wireless communication device 120 of FIG. 1) may be an ESL and may receive a price update in a PA from the access point (e.g., access point 110 of FIG. 1) in scan period 310. The PA received at device 3 305c may include a designated start time for the response period 324 or may include a schedule of response start times for devices including device 3 305c. The response by device 3 305c to the access point (e.g., access point 110 of FIG. 1) may include an acknowledgement, a status code, and/or other information such as battery life, received signal strength, and/or an error notification. The response by device 3 305c may include information to be relayed to another device by the access point (e.g., access point 110 of FIG. 1). The response may include a packet with a header and may conform to any of the Bluetooth protocols. A response may be transmitted in a data channel of the Bluetooth protocol to the access point (e.g., access point 110 of FIG. 1). Both the PA and the responses from all of the devices (e.g., device 1 305a, device 2 305b, device 3 305c, device 4 305d, and device 5 305e) may use channels of the Bluetooth protocol.

A device (e.g., device 5 305e) that has been assigned a response period may not respond and may determine that it has nothing to signal. In other words, the devices (e.g., device 1 305a, device 2 305b, device 3 305c, device 4 305d, and device 5 305c) may determine what response, if any, is required and may or may not respond to a request sent from the access point (e.g., access point 110 of FIG. 1). The response periods 320, 322, 324, 326, 328 may be assigned based on a request for such a period in an open transmission time, the request being sent to the access point (e.g., access point 110 of FIG. 1). The response periods 320, 322, 324, 326, 328 may be assigned based on which devices have been requested by the access point (e.g., access point 110 of FIG. 1) to send data or acknowledgements. The PA messages and responses may be frequency-hopped, time synchronized channels, and/or extended channels of the advertisement channels in Bluetooth.

As previously mentioned, FIG. 4 shows an example PAwR for two groups of wireless network devices 420a, 420b (e.g., a first group including ESL 1 to ESL 11, and a second group including ESL 12 to ESL 22). In particular, FIG. 4 is a signaling diagram illustrating an example of communication transmissions 400 between a network device 410 (e.g., a central device, which may be an access point) and two groups of wireless communication devices 420a, 420b (e.g., peripheral devices, which may be ESLs). With reference to FIG. 1, the signal sequence illustrated in FIG. 4 may be implemented by one or more of the communication connections, access points 110, and/or wireless communication devices 120 of FIG. 1.

In FIG. 4, the signaling diagram is shown in the form of a graph with an x-axis denoting time in milliseconds (ms) and a y-axis denoting specific wireless communication devices 420a, 420b (e.g., ESL 1, ESL 2, ESL 3, ESL 4, ESL 5, ESL 6, ESL 7, ESL 8, ESL 9, ESL 10, ESL 11, ESL 12, ESL 13, ESL 14, ESL 15, ESL 16, ESL 17, ESL 18, ESL 19, ESL 20, ESL 21, and ESL 22). In particular, the x-axis of the graph of FIG. 4 denotes time starting from 0 ms and ending at 25 ms. The time can be divided into two subframes, which are each a length of 12.5 ms. As such, the two subframes may include a first subframe from 0 ms to 12.5 ms, and a second subframe from 12.5 ms to 25 ms. In one or more examples, there may be more or less than two subframes as is shown in FIG. 4, and/or each subframe may be longer or shorter than 12.5 ms as shown in FIG. 4.

In one or more examples, the wireless communication devices 420a, 420b (e.g., peripheral devices) may be assigned (e.g., by the network device 410 and/or by a network entity, such as a management entity) to different groups (e.g., two groups) of wireless communication devices 420a, 420b. For example, wireless communication devices 420a (e.g., ESL 1, ESL 2, ESL 3, ESL 4, ESL 5, ESL 6, ESL 7, ESL 8, ESL 9, ESL 10, and ESL 11) may be assigned to a first group (e.g., group 1), and wireless communication devices 420b (e.g., ESL 12, ESL 13, ESL 14, ESL 15, ESL 16, ESL 17, ESL 18, ESL 19, ESL 20, ESL 21, and ESL 22) may be assigned to second group (e.g., group 2).

In FIG. 4, during operation for PAwR, at time 0 ms for the first subframe of time, the network device 410 (e.g., a central, such as an AP) may transmit 430a to a first group (e.g., group 1) of wireless communication devices 420a (e.g., ESL 1, ESL 2, ESL 3, ESL 4, ESL 5, ESL 6, ESL 7, ESL 8, ESL 9, ESL 10, and ESL 11) a PA containing a synchronization message (e.g., an AP synchronization message) over a synchronized channel between the network device 410 and the wireless communication devices 420a, 420b. As noted previously, a synchronization message can include one or more commands. For instance, a command can include an operational code (OpCode) and parameters associated with the command. At time 0 ms, the first group of wireless communication devices 420a (e.g., ESL 1, ESL 2, ESL 3, ESL 4, ESL 5, ESL 6, ESL 7, ESL 8, ESL 9, ESL 10, and ESL 11) can receive 435a the PA containing the synchronization message over the synchronized channel.

In one or more examples, the network device 410 may be configured to transmit PAs at a specified time interval (e.g., a subframe of time), such as at every 12.5 ms as is shown in FIG. 4. In one or more examples, the specified time interval (e.g., a subframe) may be shorter or longer than the 12.5 ms as is shown in FIG. 4. The wireless communication devices 420a, 420b may respond to a PA by using their specific respective response slot in time.

In one or more examples, the synchronization message transmitted 430a to the first group (e.g., group 1) of wireless communication devices 420a (e.g., ESL 1, ESL 2, ESL 3, ESL 4, ESL 5, ESL 6, ESL 7, ESL 8, ESL 9, ESL 10, and ESL 11) may indicate a respective response slot for one or more of the wireless communication devices 420a (e.g., ESL 1, ESL 2, ESL 3, ESL 4, ESL 5, ESL 6, ESL 7, ESL 8, ESL 9, ESL 10, and/or ESL 11) in the first group to use to transmit 440a a response to the network device 410. If a wireless communication device 420a (e.g., ESL 1, ESL 2, ESL 3, ESL 4, ESL 5, ESL 6, ESL 7, ESL 8, ESL 9, ESL 10, and ESL 11) is addressed within the synchronization message, the wireless communication device 420a (e.g., ESL 1, ESL 2, ESL 3, ESL 4, ESL 5, ESL 6, ESL 7, ESL 8, ESL 9, ESL 10, and ESL 11) can respond (e.g., transmit 440a) in its respective response slot, as indicated within the synchronization message.

For example, the synchronization message may indicate a specific sequence for one or more of the wireless communication devices 420a (e.g., ESL 1, ESL 2, ESL 3, ESL 4, ESL 5, ESL 6, ESL 7, ESL 8, ESL 9, ESL 10, and/or ESL 11) to respond (e.g., transmit 440a) in time (e.g., responding after 5 ms has elapsed after the start of the subframe at response slots located every 0.625 ms). For example, the sequence may indicate that wireless communication device 420a (e.g., ESL 1) should respond in a response slot located at 5 ms, wireless communication device 420a (e.g., ESL 2) should respond in a response slot located at 5.625 ms, wireless communication device 420a (e.g., ESL 3) should respond in a response slot located at 6.25 ms, wireless communication device 420a (e.g., ESL 4) should respond in a response slot located at 6.875 ms, wireless communication device 420a (e.g., ESL 5) should respond in a response slot located at 7.5 ms, wireless communication device 420a (e.g., ESL 6) should respond in a response slot located at 8.125 ms, wireless communication device 420a (e.g., ESL 7) should respond in a response slot located at 8.75 ms, wireless communication device 420a (e.g., ESL 8) should respond in a response slot located at 9.375 ms, wireless communication device 420a (e.g., ESL 9) should respond in a response slot located at 10 ms, wireless communication device 420a (e.g., ESL 10) should respond in a response slot located at 10.625 ms, and wireless communication device 420a (e.g., ESL 11) should respond in a response slot located at 11.25 ms.

After the wireless communication devices 420a (e.g., ESL 1, ESL 2, ESL 3, ESL 4, ESL 5, ESL 6, ESL 7, ESL 8, ESL 9, ESL 10, and ESL 11) have received 435a the PA containing the synchronization message from the network device 410, according to the sequence specified within the synchronization message, the one or more wireless communication devices 420a (e.g., ESL 1, ESL 2, ESL 3, ESL 4, ESL 5, ESL 6, ESL 7, ESL 8, ESL 9, ESL 10, and/or ESL 11) can transmit 440a their responses within their respective response slots. After the one or more wireless communication devices 420a (e.g., ESL 1, ESL 2, ESL 3, ESL 4, ESL 5, ESL 6, ESL 7, ESL 8, ESL 9, ESL 10, and/or ESL 11) have transmitted 440a their responses in their respective response time slots, the network device 410 can receive 445a their transmitted responses at those specific response slot times.

During operation for PAwR, at time 12.5 ms for the second subframe of time, the network device 410 may transmit 430b to a second group (e.g., group 2) of wireless communication devices 420b (e.g., ESL 12, ESL 13, ESL 14, ESL 15, ESL 16, ESL 17, ESL 18, ESL 19, ESL 20, ESL 21, and ESL 22) a PA containing a synchronization message over a synchronized channel between the network device 410 and the wireless communication devices 420a, 420b. In addition, at time 12.5 ms, the second group of wireless communication devices 420b (e.g., ESL 12, ESL 13, ESL 14, ESL 15, ESL 16, ESL 17, ESL 18, ESL 19, ESL 20, ESL 21, and ESL 22) can receive 435b the PA containing the synchronization message over the synchronized channel.

The synchronization message transmitted 430b to the second group (e.g., group 2) of wireless communication devices 420b (e.g., ESL 12, ESL 13, ESL 14, ESL 15, ESL 16, ESL 17, ESL 18, ESL 19, ESL 20, ESL 21, and ESL 22) may indicate a respective response slot for one or more of the wireless communication devices 420b (e.g., ESL 12, ESL 13, ESL 14, ESL 15, ESL 16, ESL 17, ESL 18, ESL 19, ESL 20, ESL 21, and/or ESL 22) in the second group to use to transmit 440b a response to the network device 410. If a wireless communication device 420b (e.g., ESL 12, ESL 13, ESL 14, ESL 15, ESL 16, ESL 17, ESL 18, ESL 19, ESL 20, ESL 21, and ESL 22) is addressed within the synchronization message, the wireless communication device 420b (e.g., ESL 12, ESL 13, ESL 14, ESL 15, ESL 16, ESL 17, ESL 18, ESL 19, ESL 20, ESL 21, and ESL 22) can respond (e.g., transmit 440b) in its respective response slot, as indicated within the synchronization message.

For example, the synchronization message may indicate a specific sequence for one or more of the wireless communication devices 420b (e.g., ESL 12, ESL 13, ESL 14, ESL 15, ESL 16, ESL 17, ESL 18, ESL 19, ESL 20, ESL 21, and/or ESL 22) to respond (e.g., transmit 440b) in time (e.g., responding after 5 ms has elapsed after the start of the subframe at response slots located every 0.625 ms). For example, the sequence may indicate that wireless communication device 420b (e.g., ESL 12) should respond in a response slot located at 17.5 ms, wireless communication device 420b (e.g., ESL 13) should respond in a response slot located at 18.125 ms, wireless communication device 420b (e.g., ESL 14) should respond in a response slot located at 18.75 ms, wireless communication device 420b (e.g., ESL 15) should respond in a response slot located at 19.375 ms, wireless communication device 420b (e.g., ESL 16) should respond in a response slot located at 20 ms, wireless communication device 420b (e.g., ESL 17) should respond in a response slot located at 20.625 ms, wireless communication device 420b (e.g., ESL 18) should respond in a response slot located at 21.25 ms, wireless communication device 420b (e.g., ESL 19) should respond in a response slot located at 21.875 ms, wireless communication device 420b (e.g., ESL 20) should respond in a response slot located at 22.5 ms, wireless communication device 420b (e.g., ESL 21) should respond in a response slot located at 23.125 ms, and wireless communication device 420b (e.g., ESL 22) should respond in a response slot located at 23.75 ms.

After the wireless communication devices 420b (e.g., ESL 12, ESL 13, ESL 14, ESL 15, ESL 16, ESL 17, ESL 18, ESL 19, ESL 20, ESL 21, and ESL 22) have received 435b the PA containing the synchronization message from the network device 410, according to the sequence specified within the synchronization message, the one or more wireless communication devices 420b (e.g., ESL 12, ESL 13, ESL 14, ESL 15, ESL 16, ESL 17, ESL 18, ESL 19, ESL 20, ESL 21, and/or ESL 22) may transmit 440b their responses within their respective response slots. After the one or more wireless communication devices 420b (e.g., ESL 12, ESL 13, ESL 14, ESL 15, ESL 16, ESL 17, ESL 18, ESL 19, ESL 20, ESL 21, and/or ESL 22) have transmitted 440b their responses in their respective response time slots, the network device 410 can receive 445b their transmitted responses at those specific response slot times. The PAwR may continue similarly for subsequent subframes of time.

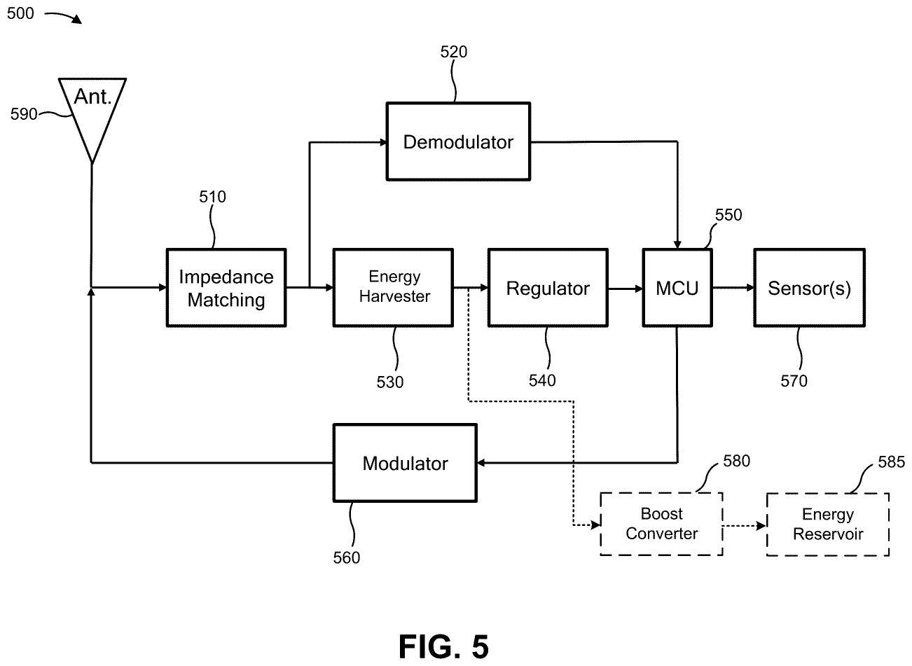

FIG. 5 is a diagram illustrating an example of an architecture of a radio frequency (RF) energy harvesting device 500, in accordance with some examples. As will be described in greater depth below, the RF energy harvesting device 500 can harvest RF energy from one or more RF signals received using an antenna 590. As used herein, the term “energy harvesting” may be used interchangeably with “power harvesting.” In some aspects, an “energy harvesting device” can be a device that is capable of performing energy harvesting (EH). For example, as used herein, the term “energy harvesting device” may be used interchangeably with the term “EH-capable device” or “energy harvesting-capable device.” In some aspects, energy harvesting device 500 can be implemented as an Internet-of-Things (IoT) device, can be implemented as a sensor, etc., as will be described in greater depth below. In other examples, energy harvesting device 500 can be implemented as a Radio-Frequency Identification (RFID) tag or various other RFID devices.

The energy harvesting device 500 includes one or more antennas 590 that can be used to transmit and receive one or more wireless signals. For example, energy harvesting device 500 can use antenna 590 to receive one or more downlink signals and to transmit one or more uplink signals. An impedance matching component 510 can be used to match the impedance of antenna 590 to the impedance of one or more (or all) of the receive components included in energy harvesting device 500. In some examples, the receive components of energy harvesting device 500 can include a demodulator 520 (e.g., for demodulating a received downlink signal), an energy harvester 530 (e.g., for harvesting RF energy from the received downlink signal), a regulator 540, a micro-controller unit (MCU) 550, a modulator 560 (e.g., for generating an uplink signal). In some cases, the receive components of energy harvesting device 500 may further include one or more sensors 570.

The downlink signals can be received from one or more transmitters. For example, energy harvesting device 500 may receive a downlink signal from a network node or network entity that is included in a same wireless network as the energy harvesting device 500. In some cases, the network entity can be a base station, gNB, etc., that communicates with the energy harvesting device 500 using a cellular communication network. For example, the cellular communication network can be implemented according to the 3G, 4G, 5G, and/or other cellular standard (e.g., including future standards such as 6G and beyond).

In some cases, energy harvesting device 500 can be implemented as a passive or semi-passive energy harvesting device (also referred to as a passive or semi-passive device), which perform passive uplink communication by modulating and reflecting a downlink signal received via antenna 590. A passive or semi-passive energy harvesting device may also be referred to as a passive or semi-passive EH-capable device, respectively. For example, passive and semi-passive energy harvesting devices may be unable to generate and transmit an uplink signal without first receiving a downlink signal that can be modulated and reflected. In other examples, energy harvesting device 500 may be implemented as an active energy harvesting device, which utilizes a powered transceiver to perform active uplink communication. An active energy harvesting device is able to generate and transmit an uplink signal without first receiving a downlink signal (e.g., by using an on-device power source to energize its powered transceiver).

An active or semi-passive energy harvesting device (e.g., also referred to as an active EH-capable device or a semi-passive EH-capable device, respectively) may include one or more energy storage elements 585 (e.g., collectively referred to as an “energy reservoir”). For example, the one or more energy storage elements 585 can include batteries, capacitors, etc. In some examples, the one or more energy storage elements 585 may be associated with a boost converter 580. The boost converter 580 can receive as input at least a portion of the energy harvested by energy harvester 530 (e.g., with a remaining portion of the harvested energy being provided as instantaneous power for operating the energy harvesting device 500). In some aspects, the boost converter 580 may be a step-up converter that steps up voltage from its input to its output (e.g., and steps down current from its input to its output). In some examples, boost converter 580 can be used to step up the harvested energy generated by energy harvester 530 to a voltage level associated with charging the one or more energy storage elements 585. An active or semi-passive energy harvesting device may include one or more energy storage elements 585 and may include one or more boost converters 580. A quantity of energy storage elements 585 may be the same as or different than a quantity of boost converters 580 included in an active or semi-passive energy harvesting device.

A passive energy harvesting device (e.g., also referred to as a “passive EH-capable device” or “passive device”) does not include an energy storage element 585 or other on-device power source. For example, a passive energy harvesting device may be powered using only RF energy harvested from a downlink signal (e.g., using energy harvester 530). As mentioned previously, a semi-passive energy harvesting device can include one or more energy storage elements 585 and/or other on-device power sources. The energy storage element 585 of a semi-passive energy harvesting device can be used to augment or supplement the RF energy harvested from a downlink signal. In some cases, the energy storage element 585 of a semi-passive energy harvesting device may store insufficient energy to transmit an uplink communication without first receiving a downlink communication (e.g., minimum transmit power of the semi-passive device>capacity of the energy storage element). An active energy harvesting device can include one or more energy storage elements 585 and/or other on-device power sources that can power uplink communication without using supplemental harvested RF energy (e.g., minimum transmit power of the active device<capacity of the energy storage element). The energy storage element(s) 585 included in an active energy harvesting device and/or a semi-passive energy harvesting device can be charged using harvested RF energy.

As mentioned above, passive and semi-passive energy harvesting devices transmit uplink communications by performing backscatter modulation to modulate and reflect a received downlink signal. The received downlink signal is used to provide both electrical power (e.g., to perform demodulation, local processing, and modulation) and a carrier wave for uplink communication (e.g., the reflection of the downlink signal). For example, a portion of the downlink signal will be backscattered as an uplink signal and a remaining portion of the downlinks signal can be used to perform energy harvesting.

Active energy harvesting devices can transmit uplink communications without performing backscatter modulation and without receiving a corresponding downlink signal (e.g., an active energy harvesting device includes an energy storage element to provide electrical power and includes a powered transceiver to generate a carrier wave for an uplink communication). In the absence of a downlink signal, passive and semi-passive energy harvesting devices cannot transmit an uplink signal (e.g., passive communication). Active energy harvesting devices do not depend on receiving a downlink signal in order to transmit an uplink signal and can transmit an uplink signal as desired (e.g., active communication).

In some aspects (e.g., in examples in which the energy harvesting device 500 is implemented as a passive or semi-passive energy harvesting device), a continuous carrier wave downlink signal may be received using antenna 590 and modulated (e.g., re-modulated) for uplink communication. In some cases, a modulator 560 can be used to modulate the reflected (e.g., backscattered) portion of the downlink signal. For example, the continuous carrier wave may be a continuous sinusoidal wave (e.g., sine or cosine waveform) and modulator 560 can perform modulation based on varying one or more of the amplitude and the phase of the backscattered reflection. Based on modulating the backscattered reflection, modulator 560 can encode digital symbols (e.g., such as binary symbols or more complex systems of symbols) indicative of an uplink communication or data message. For example, the uplink communication may be indicative of sensor data or other information associated with the one or more sensors 570 included in energy harvesting device 500.

As mentioned previously, impedance matching component 510 can be used to match the impedance of antenna 590 to the receive components of energy harvesting device 500 when receiving the downlink signal (e.g., when receiving the continuous carrier wave). In some examples, during backscatter operation (e.g., when transmitting an uplink signal), modulation can be performed based on intentionally mismatching the antenna input impedance to cause a portion of the incident downlink signal to be scattered back. The phase and amplitude of the backscattered reflection may be determined based on the impedance loading on the antenna 590. Based on varying the antenna impedance (e.g., varying the impedance mismatch between antenna 590 and the remaining components of energy harvesting device 500), digital symbols and/or binary information can be encoded (e.g., modulated) onto the backscattered reflection. Varying the antenna impedance to modulate the phase and/or amplitude of the backscattered reflection can be performed using modulator 560.

As illustrated in FIG. 5, a portion of a downlink signal received using antenna 590 can be provided to a demodulator 520, which performs demodulation and provides a downlink communication (e.g., carried or modulated on the downlink signal) to a micro-controller unit (MCU) 550 or other processor included in the energy harvesting device 500. A remaining portion of the downlink signal received using antenna 590 can be provided to energy harvester 530, which harvests RF energy from the downlink signal. For example, energy harvester 530 can harvest RF energy based on performing alternating current (AC)-to-direct current (DC) conversion, where an AC current is generated from the sinusoidal carrier wave of the downlink signal and the converted DC current is used to power the energy harvesting device 500. In some aspects, energy harvester 530 can include one or more rectifiers for performing AC-to-DC conversion. A rectifier can include one or more diodes or thin-film transistors (TFTs). In one illustrative example, energy harvester 530 can include one or more Schottky diode-based rectifiers. In some cases, energy harvester 530 can include one or more TFT-based rectifiers.

The output of the energy harvester 530 is a DC current generated from (e.g., harvested from) the portion of the downlink signal provided to the energy harvester 530. In some aspects, the DC current output of energy harvester 530 may vary with the input provided to the energy harvester 530. For example, an increase in the input current to energy harvester 530 can be associated with an increase in the output DC current generated by energy harvester 530. In some cases, MCU 550 may be associated with a narrow band of acceptable DC current values. Regulator 540 can be used to remove or otherwise decrease variation(s) in the DC current generated as output by energy harvester 530. For example, regulator 540 can remove or smooth spikes (e.g., increases) in the DC current output by energy harvester 530 (e.g., such that the DC current provided as input to MCU 550 by regulator 540 remains below a first threshold). In some cases, regulator 540 can remove or otherwise compensate for drops or decreases in the DC current output by energy harvester 530 (e.g., such that the DC current provided as input to MCU 550 by regulator 540 remains above a second threshold).

In some aspects, the harvested DC current (e.g., generated by energy harvester 530 and regulated upward or downward as needed by regulator 540) can be used to power MCU 550 and one or more additional components included in the energy harvesting device 500. For example, the harvested DC current can additionally be used to power one or more (or all) of the impedance matching component 510, demodulator 520, regulator 540, MCU 550, sensors 570, modulator 560, etc. For example, sensors 570 and modulator 560 can receive at least a portion of the harvested DC current that remains after MCU 550 (e.g., that is not consumed by MCU 550). In some cases, the harvested DC current output by regulator 540 can be provided to MCU 550, modulator 560, and sensors 570 in series, in parallel, or a combination thereof.

In some examples, sensors 570 can be used to obtain sensor data (e.g., such as sensor data associated with an environment in which the energy harvesting device 500 is located). Sensors 570 can include one or more sensors, which may be of a same or different type(s). In some aspects, one or more (or all) of the sensors 570 can be configured to obtain sensor data based on control information included in a downlink signal received using antenna 590. For example, one or more of the sensors 570 can be configured based on a downlink communication obtained based on demodulating a received downlink signal using demodulator 520. In one illustrative example, sensor data can be transmitted based on using modulator 560 to modulate (e.g., vary one or more of amplitude and/or phase of) a backscatter reflection of the continuous carrier wave received at antenna 590. Based on modulating the backscattered reflection, modulator 560 can encode digital symbols (e.g., such as binary symbols or more complex systems of symbols) indicative of an uplink communication or data message. In some examples, modulator 560 can generate an uplink, backscatter modulated signal based on receiving sensor data directly from sensors 570. In some examples, modulator 560 can generate an uplink, backscatter modulated signal based on received sensor data from MCU 550 (e.g., based on MCU 550 receiving sensor data directly from sensors 570).

FIG. 6 is a diagram illustrating an example of transmission timelines 600 associated with discovery and synchronization between access points (e.g., access points 110 of FIG. 1). As shown, example 300 includes access points (e.g., access points 110 of FIG. 1), shown as APᵢ 610 and APⱼ 620 on the transmission timelines 600. The access points APᵢ 610 and APⱼ 620 may be communicatively connected to a management entity (e.g., management entity 130 of FIG. 1). In some aspects, the access points and/or the management entity may be included in a wireless communication system, such as an ESL system. The wireless communication system may use a wireless communication technology, such as BLE.

As used herein, “transmission timing” or “periodic advertisement timing” may refer to a timing or schedule by which a device (e.g., an access point) transmits communications or periodic advertisements. For example, two devices that use (e.g., that are synchronized to) the same periodic advertisement timing may transmit periodic advertisements concurrently.

In one or more examples, during operation, a first access point AP1 (e.g., APᵢ 610) may transmit (e.g., broadcast) periodic advertisements (e.g., PAs 630a, 630b), such as a train of periodic advertisements. The periodic advertisements may be unidirectional broadcast messages. The first access point AP1 may transmit periodic advertisements in accordance with a PAwMR schedule. Moreover, the first access point AP1 may transmit the periodic advertisements using a first hopping frequency sequence (HFS). The first HFS may be an HFS configured for the first access point AP1 (e.g., if the first access point AP1 is not a follower of another access point), or the first HFS may be different from a reference HFS based at least in part on a first index value associated with (e.g., selected by) the first access point AP1.

A second access point AP2 (e.g., APⱼ 620) may detect at least one periodic advertisement broadcast from the first access point AP1 (e.g., by scanning known channels on which the first access point AP1 performs transmissions and/or by scanning, or taking a snapshot of, an entire band). That is, the second access point AP2 may discover the first access point AP1. In some aspects, the second access point AP2 may listen on one or more advertisement channels (e.g., advertisement channels) to detect information that enables the second access point AP2 to follow and synchronize with the first access point AP1, thereby enabling the second access point AP2 to monitor for the periodic advertisement(s) (e.g., PAs 630a, 630b). In some aspects, the second access point AP2 may monitor for (e.g., listen for) and detect the periodic advertisement(s) prior to initiation of periodic advertisement transmissions by the second access point AP2 (which may be referred to as a “detect before proceed” policy). For example, in a boot sequence during starting (or re-starting) of the second access point AP2, the second access point AP2 may listen for periodic advertisements from other access points before starting periodic advertisement transmissions. In some aspects, access points (e.g., isolated access points), such as the second access point AP2, may periodically listen for periodic advertisements from neighboring access points.

Based on detecting a periodic advertisement from the first access point AP1, the second access point AP2 may transmit, and the first access point AP1 may receive, a message (e.g., an unsolicited message) to initiate a connection between the first access point AP1 and the second access point AP2. Following the connection, or as part of the connection procedure, the first access point AP1 may transmit, and the second access point AP2 may receive, a synchronization message. The synchronization message may identify the periodic advertisement timing (e.g., the PAwMR schedule) used by the first access point AP1. For example, the synchronization message may include PAST information that indicates the periodic advertising timing used by the first access point AP1 (e.g., by indicating a time offset used by the first access point AP1). In some cases, the PAST information may also include the values of all of the parameters required for HFS computation as well as a channel map. In addition, or alternatively, the synchronization message may identify the first HFS used by the first access point AP1. For example, the PAST information may also indicate a reference HFS used by the first access point AP1, and the first HFS may be the reference HFS or an HFS that is shifted (e.g., frequency shuffled) from the reference HFS. For example, if an HFS is shifted from a reference HFS, then at all frequency instances in a frequency sequence, a channel index of the HFS may be different from a channel index of the reference HFS. In some aspects, the synchronization message may identify the first HFS used by the first access point AP1 by indicating the first index value associated with the first access point AP1 (e.g., the first HFS may be determined using the first index value and the reference HFS). For example, the synchronization message may indicate a set of index values that includes the first index value and/or one or more additional index values, associated with additional access points, known to the first access point AP1. In some aspects, the set of index values may include an index value for the second access point AP2 that indicates an HFS to be used by the second access point AP2.

The exchange of periodic advertising timing information (e.g., the exchange of PAST information) may enable the second access point AP2 to synchronize with the first access point AP1. Accordingly, in the same manner, multiple additional access points may synchronize to the same periodic advertisement timing. For example, a third access point AP3 may also synchronize with the first access point AP1, and a fourth access point AP4 may synchronize with the third access point AP3, thereby resulting in the fourth access point AP4 being synchronized with the second access point AP2 by transitive synchronization. In this way, multiple access points may become time synchronized with each other.

As shown by reference number 655, based on receiving the synchronization message, the second access point AP2 may transmit periodic advertisements (e.g., PAs 640a, 640b), such as transmissions on a data channel, synchronized with the periodic advertisement timing (e.g., the PAwMR schedule) used by the first access point AP1. In this way, periodic advertisements are transmitted concurrently by the first access point AP1 and the second access point AP2. However, the second access point AP2 may transmit the periodic advertisements according to a second HFS. The second HFS may be offset from (e.g., different from) the first HFS used by the first access point AP1 or a reference HFS. In other words, each of the access points (e.g., with physically overlapping coverage areas) may use an HFS that is different from an HFS of any of the other access points. By using different HFSs, interference among the access points may be avoided despite the access points being time synchronized. As such, for any two HFSs of different APs, the probability of selecting the same channel at the same instant of time should be low.

The second HFS may be based at least in part on a second index value (e.g., different from the first index value) associated with the second access point AP2. For example, each of the access points (e.g., with physically overlapping coverage areas) may be associated with a different index value from any of the other access points.

Accordingly, based at least in part on the set of index values identified to the second access point AP2, the second access point AP2 may select the second index value to achieve an HFS (e.g., in a radio frequency range of the second access point AP2) that is orthogonal to every other HFS currently in use. In some aspects, the second HFS may be shifted relative to the first HFS or the reference HFS based at least in part on the second index value. For example, the second HFS may be determined according to Equation 1 below:

HFSᵢ=(HFS₀+indexᵢ)mod 37 Equation 1

where HFS₀ is the reference HFS, HFSᵢ is the HFS being determined, and indexᵢ is the index value used to determine the HFS. Equation 1 uses a value of 37 for the modulo operation because a BLE system uses 37 data channels. However, a different value for the modulo operation may be used (e.g., corresponding to a quantity of channels) in other systems.

In some aspects, an index value may indicate an HFS in a manner other than as described above. That is, an index value may be any means to identify a hopping frequency channel (or “channel selection”) sequence. For example, each access point and each wireless communication device may be configured with a set of HFSs, and an index value may map to a particular HFS of the set of HFSs. Thus, indication of a set of index values, as described herein, may refer to the indication of all active (e.g., in use) HFSs of the set of HFSs.

In some aspects, the first access point AP1 may transmit, and one or more wireless communication devices (e.g., wireless communication devices 120 of FIG. 1) may receive, information identifying the periodic advertisement timing (e.g., PAST information) used by the first access point AP1. For example, the first access point AP1 may transmit the information in connection with onboarding the wireless communication device(s) to the first access point AP1. In some aspects, the second access point AP2 may transmit, and one or more wireless communication devices (e.g., wireless communication devices 120) may receive, information identifying the periodic advertisement timing (e.g., PAST information) used by the second access point AP2. For example, the second access point AP2 may transmit the information to wireless communication devices already onboarded with the second access point AP2, or the second access point AP2 may cause the wireless communication devices to repeat an onboarding procedure with the second access point AP2 during which the information is transmitted.

In some aspects, the first access point AP1 may transmit (e.g., via broadcast), and one or more wireless communication devices (e.g., wireless communication devices 120 of FIG. 1) synchronized to the first access point AP1 may receive, information identifying a set of (e.g., one or more) index values indicating HFSs used by one or more access points. For example, the set of index values may include the first index value associated with the first access point AP1, the second index value associated with the second access point AP2, and/or one or more additional index values, associated with additional access points, known to the first access point AP1. Similarly, in some aspects, the second access point AP2 may transmit (e.g., via broadcast), and one or more wireless communication devices (e.g., wireless communication devices 120 of FIG. 1) synchronized to the second access point AP2 may receive, information identifying a set of (e.g., one or more) index values indicating HFSs used by one or more access points. For example, the one or more index values may include the first index value associated with the first access point AP1, the second index value associated with the second access point AP2, and/or one or more additional index values, associated with additional access points, known to the second access point AP2. In some aspects, the first access point AP1 and/or the first access point AP1 may receive, from the management entity, information indicating the index values that are in use (e.g., valid indexes) for one or more additional access points.

Over time (e.g., due to clock drift), the periodic advertisement timing used by the first access point AP1 and the second access point AP2 may become misaligned. As shown by reference number 650, the second access point AP2 may monitor (e.g., sporadically) for an additional periodic advertisement from the first access point AP1 in a monitoring opportunity. In other words, the second access point AP2 may sacrifice a periodic advertisement transmission (e.g., for a particular group of wireless communication devices) in order to monitor (e.g., listen) for the additional periodic advertisement from the first access point AP1. In some aspects, the monitoring opportunity, in which the second access point AP2 monitors for the additional periodic advertisement, may be based at least in part on an expected clock drift between the first access point AP1 and the second access point AP2. Based on a timing of the additional periodic advertisement, the periodic advertisement timing may be realigned between the first access point AP1 and the second access point AP2. For example, the second access point AP2 may realign with the periodic advertisement timing used by the first access point AP1 based at least in part on a timing of the additional periodic advertisement (e.g., based at least in part on a difference between the actual timing of the additional periodic advertisement and an expected timing of the additional periodic advertisement).

In some examples, an access point that uses a transmission timing or schedule (e.g., a periodic advertisement timing or schedule) that is followed by another access point may be referred to as a “leader access point,” and an access point that synchronizes its transmission timing or schedule to the transmission timing or schedule of another access point may be referred to as a “follower access point.” In some cases, an access point may be both a leader access point and a follower access point. For example, the transmission timing or schedule used by a first access point may be followed by a second access point, and a third access point may follow the transmission timing or schedule used by the second access point. Thus, in this example, the second access point is both a leader access point and a follower access point.

As indicated above, FIG. 6 is provided as an example. Other examples may differ from what is described with respect to FIG. 6.

As previously mentioned, RFEH is currently a growing technology, and has become beneficial for applications in retail environments (e.g., especially in applications linked to ESL systems). Some RFEH devices (e.g., wireless communication devices, such as wireless communication devices 120, in the form of batteryless tags or labels) can use BLE signals as an information bearer (e.g., a carrier of the information). After having accumulated a sufficient amount of energy for transmission, RFEH devices can issue (transmit) a BLE beacon signal (e.g., transmitted within a specified response slot for transmission on a BLE advertisement channel). These beacon signals may be used for tracking assets associated with the RFEH devices. Each beacon signal may contain an ID and/or other information or characteristic (e.g., unique information or characteristic) associated with its respective RFEH device and, optionally, sensor data (e.g., temperature, humidity, etc.) obtained by one or more optional sensors implemented within its associated RFEH device. Congestion on the BLE advertisement channels (e.g., BLE channels 37, 38, and 39) can make a successful issuing (transmission) of a beacon signal from these RFEH devices (e.g., ESLs) difficult. BLE protocol compliant alternatives to using these BLE advertisement channels (e.g., channels 37, 38, and 39) need to be provided to increase the probability of detection of the beacon signals.

A limited allowable amount of energy harvesting can lead to a limited amount of available power for transmission by the RFEH devices (e.g., wireless communication devices in the form of batteryless tags or labels). Traditional non-connectable advertisements transmitted (e.g., on the BLE advertisement channels) from BLE devices can compete with all other BLE systems. Interference on the BLE advertisement channels (e.g., BLE channels 37, 38, and 39) is usually very high in retail environments, such as where competition of signals within a visible light communication (VLC) system can lead to a fallback system that employs a dense usage of beacon signals). As such, weak signals (e.g., transmissions from the RFEH devices), which are transmitted on these BLE advertisement channels, can be swamped (e.g., interfered with) by many other beacon signals (beacons).

The RFEH devices (e.g., wireless communication devices in the form of batteryless tags or labels) can collect energy from RF signals through the use of a rectifier, a PMIC, and a capacitor employed by the RFEH devices. The energy source (e.g., a device transmitting the RF signals for energy harvesting, such as an energizer) is not necessarily linked or common to the BLE 2.4 GHz frequency. RFEH devices operate using an internal local OSC, which is low cost and low power. The local OSC of the RFEH devices needs to be tuned to the Tx frequency for the RFEH devices. The RFEH devices can use a preamble of a beacon signal (e.g., transmitted on a BLE advertisement channel) to tune their local OSCs to the Tx frequency.

BLE radio may be limited in its functionalities. BLE radio can have a limited frequency “agility” or flexibility. For example, the beacon signal, including the preamble, may need to be transmitted on a channel (e.g., on a frequency) that is near (close to) a channel for the Tx frequency for an RFEH device. BLE radio can also be limited in that signal demodulation (e.g., beyond the preamble) may not necessarily be available. As such, an improved solution for transmissions by RFEH devices (e.g., wireless communication devices in the form of batteryless tags or labels) of signals (e.g., beacon signals) with less interference can be beneficial.

In one or more aspects, the systems and techniques provide solutions for wireless communication devices (e.g., RFEH devices in the form of batteryless tags or labels) to transmit signals (e.g., beacon signals) successfully with a reduced amount of interference. In some aspects, systems and techniques are provided for wireless communication devices (e.g., RFEH devices in the form of batteryless tags or labels) advertising using a periodic advertisement (PA). In one or more aspects, the systems and techniques can employ, for the transmissions of signals (e.g., beacon signals) by the wireless communication devices, BLE data channels (e.g., BLE channels 0 through 36), which are less crowded (and, as such, have less interference) than the BLE advertisement channels (e.g., BLE channels 37, 38, and 39). In one or more aspects, the timing of the transmitting and receiving of the wireless communication devices (e.g., RFEH devices in the form of batteryless tags or labels) can be synchronized by using energy burst boundaries or by using an ESL-energy (ESL-e) beacon signal.

As noted previously, in one or more examples, a first example solution involves the use of energy burst boundaries, where one or more wireless communication devices (e.g., RFEH devices in the form of batteryless tags or labels) can each operate as a central and send its beacon signal at a specific channel time interval, which can be specified by energy burst boundaries.

As also noted previously, in some examples, a second example solution involves the use of PAwR, where a network device (e.g., a scanner in the form of an access point or an ESL-e) can operate as a central and send a PA. The PAwR is beaconed on a given data channel that is deterministic without further data exchange towards the wireless communication device(s). For the second example solution, one or more wireless communication devices (e.g., RFEH devices in the form of batteryless tags or labels) can each send its beacon signal (e.g., as a response to the PA) at a specific channel (e.g., a BLE data channel) and time interval, which can be specified by the PA. In some cases, a wireless communication device (e.g., the RFEH device) can receive enough energy to scan for a PAwR beacon from a network device. The network device can scan for the beacon from the wireless communication device (and in some cases other wireless communication devices) as a PAwR response. In some cases, wireless communication devices (e.g., RFEH devices) can transmit beacon(s) in a predefined data channel and time slot as PA central devices, and the network device can schedule their PAwR request sending and response scanning at the same predefined channel and slot.

In one or more aspects, BLE data channels (e.g., BLE channels 0 through 36), which are compatible to the BLE protocol and do not require a communication exchange with the wireless communication devices (e.g., RFEH devices in the form of batteryless tags or labels) ahead of their beacon transmission, are employed instead of the BLE advertisement channels (e.g., BLE channels 37, 38, and 39) for the transmissions of signals by the wireless communication devices.

In one or more aspects, a PA can be the basis for the disclosed solutions for wireless communication devices (e.g., RFEH devices in the form of batteryless tags or labels) to transmit signals (e.g., beacon signals) successfully. In one or more examples, a central (e.g., which may be in the form of a network device, such as an AP) can periodically transmit on a pre-defined data channel (e.g., a BLE data channel) a PA. The selection of the data channel may be dependent upon the definition of the PA train, may be arbitrary (e.g., diverse, forming a hopping frequency sequence), or may be constant (e.g., selecting a single channel). In one or more examples, there may be no constraint for the central to be confined to one single physical device (e.g., any device with the correct information that follows the periodicity of the transmission can operate as the central with respect to the PA train). PAwR can be employed, where a central (e.g., which may be in the form of a network device, such as an AP) can be used to provide the timing for the response slots, which can be used for transmission by the wireless communication devices of their beacon signals. In one or more examples, the data channel (e.g., a BLE data channel) to be used for the transmissions can be agreed upon or defined during the manufacturing of the devices (e.g., at the configuration level of manufacturing).

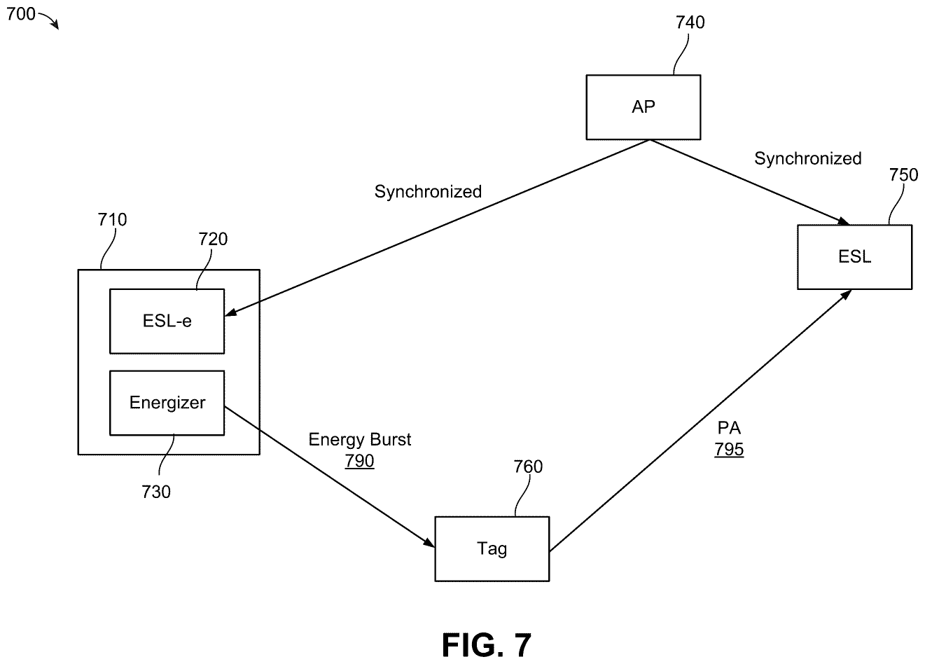

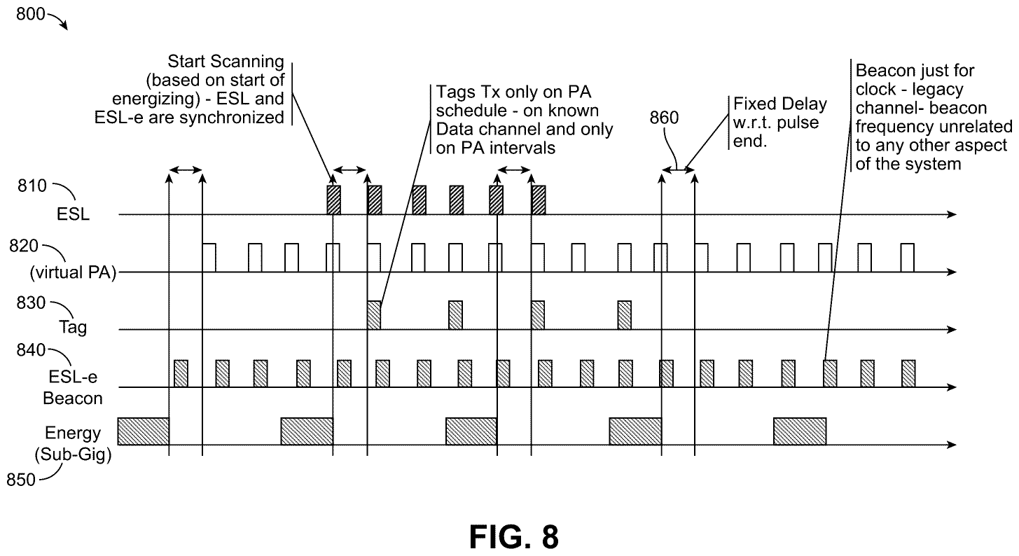

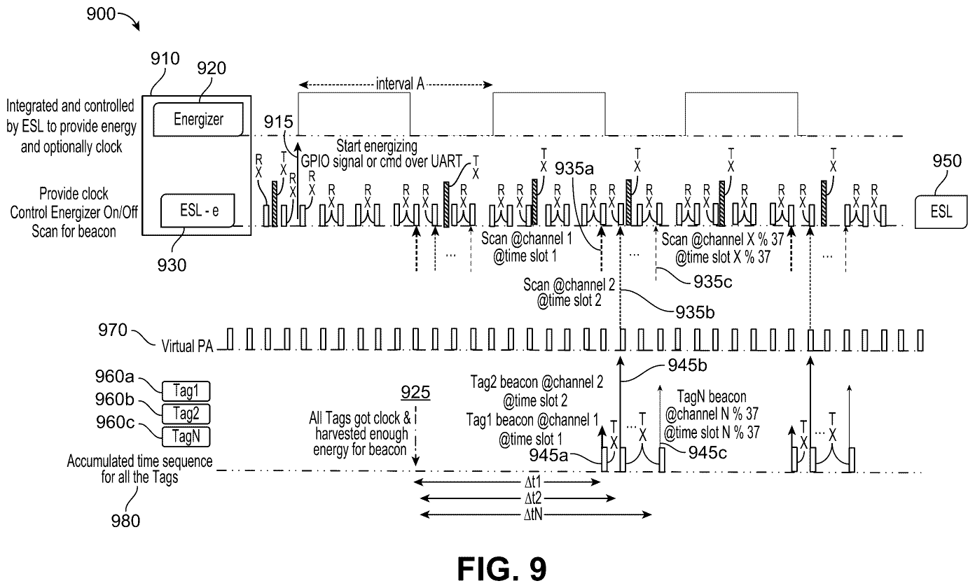

In one or more aspects, there are different options for the disclosed solutions for wireless communication devices (e.g., RFEH devices in the form of batteryless tags or labels) to transmit signals (e.g., beacon signals) successfully with a reduced amount of interference. For a first option, corresponding to the first example solution described previously, an “abstract” or virtual PA can be created. The virtual PA (e.g., virtual PA 820 of FIG. 8 and/or virtual PA 970 of FIG. 9) is a virtual signal including virtual pulses, which are not actually transmitted. The virtual PA can define the timing for the receiving and transmitting by the wireless communication devices (e.g., RFEH devices in the form of batteryless tags or labels, such as tag 760 of FIG. 7 and/or tags 960a, 960b, 960c of FIG. 9). The channel (e.g., a BLE data channel) and schedule for transmitting (e.g., of a beacon signal) and receiving by each of the wireless communication devices (e.g., which may each be operating as a central) can be agreed upon during the manufacturing process of the wireless communication devices and known by the wireless communication devices. The wireless communication devices can use a boundary of an energy burst for synchronizing their clocks such that their specific schedule is synchronized with the PA interval. The wireless communication devices can then send (transmit) their beacon signals at the specific channel (e.g., a BLE data channel) and transmit slot, according to their respective schedule at the synchronized PA time interval.

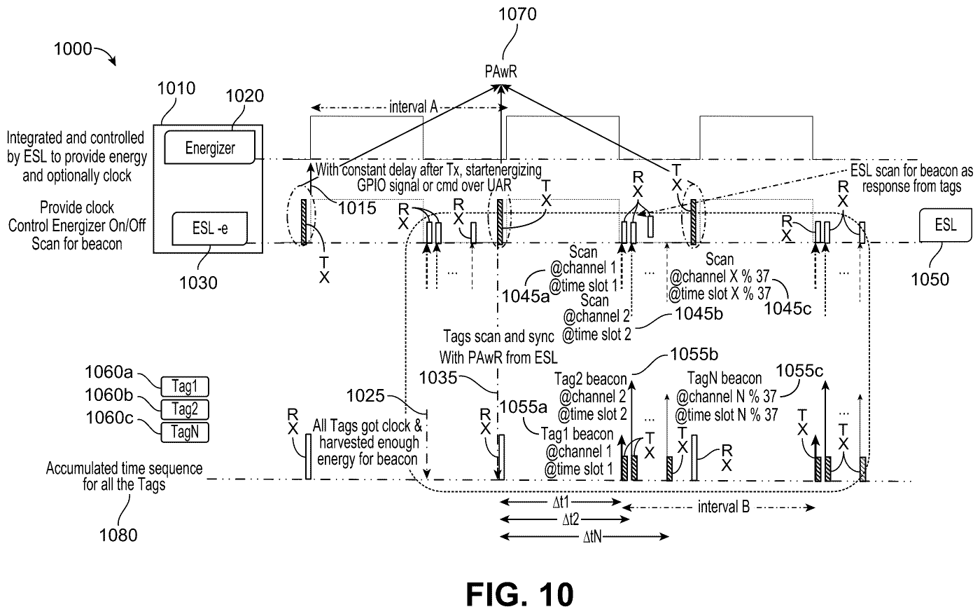

For a second option, corresponding to the second example solution described previously, a network device (e.g., a scanner in the form of an access point, such as access point 110 of FIG. 1 and/or AP 740 of FIG. 7; or an ESL-e, such as ESL-e 720 of FIG. 7 and/or ESL-e 1030 of FIG. 10) can operate as a central and can transmit a PA to one or more wireless communication devices (e.g., RFEH devices in the form of batteryless tags, such as tag 760 of FIG. 7 and/or tags 960a, 960b, 960c of FIG. 9). The channel (e.g., a BLE data channel) and schedule for transmitting (e.g., of a beacon signal) and receiving by each of the wireless communication devices (e.g., which may each be operating as a central) can be agreed upon during the manufacturing process of the wireless communication devices and known by the wireless communication devices. The wireless communication devices can use the PA for synchronizing their clocks (timing) such that their specific timing schedules are synchronized with the PA interval. The wireless communication devices can then send (transmit) their beacon signals at the specific channel (e.g., a BLE data channel) and response slot (e.g., PAwR response slot) according to their respective schedule at the synchronized PA time interval.

FIG. 7 shows an example system that may be employed for both the first and second options. In particular, FIG. 7 is a diagram illustrating an example of a system 700 for batteryless wireless communication devices (e.g., batteryless tags or labels) advertising using a periodic advertisement. In FIG. 7, an energy device 710, an AP 740 (e.g., access point 110 of FIG. 1), an ESL 750 (e.g., wireless communication device 120 of FIG. 1), and a tag 760 (e.g., an RFEH device), which may be batteryless, are shown. The energy device 710 may include an ESL-e 720 (e.g., wireless communication device 120 of FIG. 1) and an energizer 730 for providing RF energy signals for energy harvesting by the tag 760.

In one or more examples, during operation of the system 700, the AP 740 may transmit signals (e.g., a PA train) to the energy device 710 and the ESL 750 for synchronization (e.g., based on ESL protocol) of the ESL-e 720 and the ESL 750 with the AP 740. The energizer 730 can be controlled (e.g., the control of the transmissions of energy bursts by the energizer 730) by the ESL-e 720 and, as such, the energizer 730 can have its operation synchronized with the ESL-e 720, the AP 740, and the ESL 750.

The ESL-e 720 can transmit an ESL-e beacon signal (e.g., a beacon signal, such as ESL-e beacon signal 840 of FIG. 8), which can be received by the tag 760. The energizer 730 can transmit energy bursts 790 in a direction towards the tag 760. The energy bursts 790 can energize the tag 760 with power.

In one or more examples, the tag 760 can synchronize its clock (timing) with a boundary (e.g., a start or stop boundary) of an energy burst 790 such that its specific timing schedule is synchronized. In some examples, the tag 760 can synchronize its clock with one or more pulses from the received ESL-e beacon signal. After the tag 760 has been sufficiently energized by the energy bursts 790 for transmissions and the tag 760 has synchronized its clock, the tag 760 can transmit its beacon signal or PA 795 (e.g., tag signal 830 of FIG. 8) within its transmit slot according to its schedule. The ESL 750, being synchronized with the tag 760, can scan (e.g., ESL signal 810 of FIG. 8) to receive the PA 795 (e.g., beacon signal) from the tag 760.

In one or more examples, the transmit slots for the tags (e.g., which include tag 760) should be at different times (e.g., have different transmit delays), if the tags are all transmitting on a same transmit channel. In some examples, the number of transmit slots for the tags (e.g., which include tag 760) should be a fraction of the energy burst interval.

FIG. 8 shows a simplified example of signaling that may be employed for the first option. In particular, FIG. 8 is a simplified diagram illustrating an example of signaling 800 for batteryless wireless communication devices (e.g., RFEH devices, such as batteryless tags or labels) advertising using a periodic advertisement, where energy bursts provide a time base as a basis for a virtual periodic advertisement (PA) to allow batteryless wireless communication devices to transmit on a data channel. In FIG. 8, an ESL signal 810, a virtual PA 820, a tag signal 830, an ESL-e beacon signal 840 (e.g., beacon signal), and an energy signal 850, which may be sub-Gigahertz (Sub-Gig), are shown.

During operation, an AP (e.g., AP 740 of FIG. 7) can send (transmit) a PA train to an ESL (e.g., ESL 750 of FIG. 7) and to an ESL-e (e.g., ESL-e 720 of FIG. 7) for synchronization, based on an ESL protocol, of the ESL 750 and the ESL-e 720 with the AP. Since an energizer (e.g., energizer 730 of FIG. 7) can be controlled by the ESL-e, the energizer can be synchronized with the ESL-e, the AP, and the ESL.

The ESL-e may send (transmit) the ESL-e beacon signal 840. A tag (e.g., tag 760 of FIG. 7) can receive the ESL-e beacon signal 840. The energizer can send (transmit) the energy signal 850 containing energy bursts towards the tag for energy harvesting by the tag. The tag can be energized by the energy bursts it receives.

The tag can synchronize its clock (timing) with a boundary (e.g., a start or stop boundary) of an energy burst from the energy signal 850 such that its specific timing schedule is synchronized. After the tag is sufficiently energized by the energy bursts of the energy signal 850 and the tag has synchronized its clock accordingly, the tag may transmit a tag signal 830 (e.g., beacon signal or PA) within its transmit slot according to its schedule. The ESL, which is synchronized with the tag (e.g., based on the procedure described with respect to FIG. 1-FIG. 4), can scan (e.g., shown as the ESL signal 810) at periodic intervals (e.g., shown as the virtual PA 820) to receive the tag signal 830 from the tag. The ESL signal 810 is thus synchronized with the virtual PA 820. The energy bursts of the energy signal 850 are aligned with respect to the virtual PA 820. For example, as shown in FIG. 8, a pulse of the virtual PA 820 will start at a fixed delta in time 860 after the end (stop) of an energy burst of the energy signal 850. The tag transmitting the tag signal 830 can transmit on a data channel (e.g., a BLE data channel) due to creation of the virtual PA 820 based on the energy signal 850. The tag transmitting the tag signal 830 (and/or other tags transmitting tag signals in some cases) can follow the schedule of the virtual PA 820 without any restriction on the channel policy or on the physical identity of a central device (e.g., the tag can operate as the central), providing flexibility and eliminating issues associated with using advertisement channels for sending tag signals (e.g., the congestion described previously), such as beacon signals.

FIG. 9 shows a detailed example of signaling that may be employed for the first option. In particular, FIG. 9 is a diagram illustrating an example of signaling 900 for batteryless wireless communication devices (e.g., RFEH devices, such as batteryless tags or labels) advertising using a periodic advertisement, where energy bursts indicate a schedule (e.g., transmit slots) for transmission by the batteryless wireless communication devices. In FIG. 9, an energy device 910, an ESL 950, and tags 960a, 960b, 960c are shown. The energy device 910 includes an energizer 920 and an ESL-e 930.

During operation, an AP (e.g., AP 740 of FIG. 7) can send (transmit) a PA train to the ESL 950 and to the ESL-e 930 for synchronization, based on an ESL protocol, of the ESL 950 and the ESL-c 930 with the AP. Since the energizer 920 is controlled by the ESL-c 930, the energizer 920 can be synchronized with the ESL-e 930, the AP, and the ESL 950. The ESL-e 930 can send (transmit) an ESL-e beacon signal (e.g., a beacon signal, as shown in FIG. 9). The tags 960a, 960b, 960c can receive the ESL-e beacon signal.

The ESL-e 930 can send an energizing signal 915 to the energizer 920 to start transmitting energy bursts. The energizing signal 915 can be transmitted by the ESL-e 930 to the energizer 920 via hardwire, such as a general purpose-input output (GPIO) or by a command by a universal asynchronous receiver-transmitter (UART). After receiving the energizing signal 915, the energizer 920 can send (transmit) the energy signal (as shown in FIG. 9) containing energy bursts towards the tags 960a, 960b, 960c for energy harvesting by the tags 960a, 960b, 960c. The tags 960a, 960b, 960c can be energized by the received energy bursts.

The tags 960a, 960b, 960c can each synchronize its respective clock (timing) with a boundary (e.g., a start or stop boundary 925, as shown in FIG. 9) of an energy burst from the energy signal such that their specific timing schedules are synchronized. The tags 960a, 960b, 960c can each calculate their respective transmit slot based on the tag ID (e.g., tag ID modulo 37) and/or based on other information (e.g., unique information) associated with the tags 960a, 960b, 960c that can be used to limit potential interference in communications from the tags 960a, 960b, 960c. For example, tag 1 960a may calculate that its transmit slot is a specific time delta (e.g., Δt1) after the stop boundary 925 of the energy burst, tag 2 960b may calculate that its transmit slot is a specific time delta (e.g., Δt2) after the stop boundary 925 of the energy burst, and tag N 960c may calculate that its transmit slot is a specific time delta (e.g., ΔtN) after the stop boundary 925 of the energy burst.

After the tags 960a, 960b, 960c are sufficiently energized by the energy bursts of the energy signal and the tags 960a, 960b, 960c have each synchronized their respective clocks accordingly, the tags 960a, 960b, 960c may each send (transmit) a tag signal (e.g., accumulated tag signals from tags 960a, 960b, 960c are shown in line 980) within their respective transmit slot accordingly. For example, tag 1 960a may transmit at transmit slot 945a, tag 2 960b may transmit at transmit slot 945b, and tag N 960c may transmit at transmit slot 945c.

The ESL 950, which is synchronized with the tags 960a, 960b, 960c, can scan (e.g., at receive slots 935a, 935b, 935c) to receive the tag signals (e.g., shown at transmit slot 945a, 945b, 945c) transmitted from the tags 960a, 960b, 960c. The ESL signal 810 is synchronized with the virtual PA 970. The energy bursts of the energy signal are aligned with respect to the virtual PA 970 (e.g., a pulse of the virtual PA 970 will start at a fixed delta in time after the end of an energy burst of the energy signal).

FIG. 10 shows a detailed example of signaling that may be employed for the second option. In particular, FIG. 10 is a diagram illustrating an example of signaling 1000 for batteryless wireless communication devices (e.g., RFEH devices, such as batteryless tags or labels) advertising using a periodic advertisement, where a periodic advertisement (PA) indicates a schedule (e.g., response slots) for transmission by the batteryless wireless communication devices. In FIG. 10, an energy device 1010, an ESL 1050, and tags 1060a, 1060b, 1060c are shown. The energy device 1010 includes an energizer 1020 and an ESL-e 1030.

During operation, an AP (e.g., AP 740 of FIG. 7) can send (transmit) a PA train (e.g., PAwR 1070) to the ESL 1050 and to the ESL-e 1030 for synchronization, based on an ESL protocol, of the ESL 1050 and the ESL-e 1030 with the AP. The energizer 1020 is controlled by the ESL-e 1030 and, as such, the energizer 1020 can be synchronized with the ESL-e 1030, the AP, and the ESL 1050.

The ESL-e 1030 may send an energizing signal 1015 to the energizer 1020 to start transmitting energy bursts. The energizing signal 1015 can be transmitted by the ESL-e 1030 to the energizer 1020 through hardwire (e.g., by GPIO or by a command by a UART). After the energizer 1020 receives the energizing signal 1015, the energizer 1020 can transmit the energy signal (as shown in FIG. 9) including energy bursts to the tags 1060a, 1060b, 1060c for energy harvesting. The tags 1060a, 1060b, 1060c can be energized by the energy bursts.

The ESL-e 1030 can transmit an ESL-e beacon signal (e.g., a beacon signal, as shown in FIG. 10), which can be received by the tags 1060a, 1060b, 1060c. The tags 1060a, 1060b, 1060c can each synchronize its respective clock with one or more of the pulses of the ESL-e beacon signal such that their specific timing schedules are synchronized. Each of the tags 1060a, 1060b, 1060c can calculate their respective transmit slot based on the tag ID (e.g., tag ID modulo 37) and/or based on other information (e.g., unique information) associated with the tags 1060a, 1060b, 1060c that can be used to limit potential interference in communications from the tags 1060a, 1060b, 1060c. For example, tag 1 1060a can calculate that its response slot is a specific time delta (e.g., Δt1) after a time of reception 1035 of a pulse from the ESL-e beacon signal, tag 2 1060b may calculate that its response slot is a specific time delta (e.g., Δt2) after a time of reception 1035 of a pulse from the ESL-e beacon signal, and tag N 1060c may calculate that its response slot is a specific time delta (e.g., ΔtN) after a time of reception 1035 of a pulse from the ESL-e beacon signal.

After the tags 1060a, 1060b, 1060c are energized by the energy bursts of the energy signal for transmission and the tags 1060a, 1060b, 1060c synchronized their respective clocks accordingly (e.g., at time 1025 of FIG. 10), the tags 1060a, 1060b, 1060c can each transmit a tag signal (e.g., accumulated tag signals from tags 1060a, 1060b, 1060c are shown in line 1080) within their respective response slot according to their timing schedule. For example, tag 1 1060a may transmit at response slot 1055a, tag 2 1060b may transmit at response slot 1055b, and tag N 1060c may transmit at response slot 1055c. The ESL 1050, which is synchronized with the tags 1060a, 1060b, 1060c, can scan (e.g., at receive slots 1045a, 1045b, 1045c) to receive the tag signals (e.g., shown at transmit slot 1055a, 1055b, 1055c) transmitted from the tags 1060a, 1060b, 1060c.

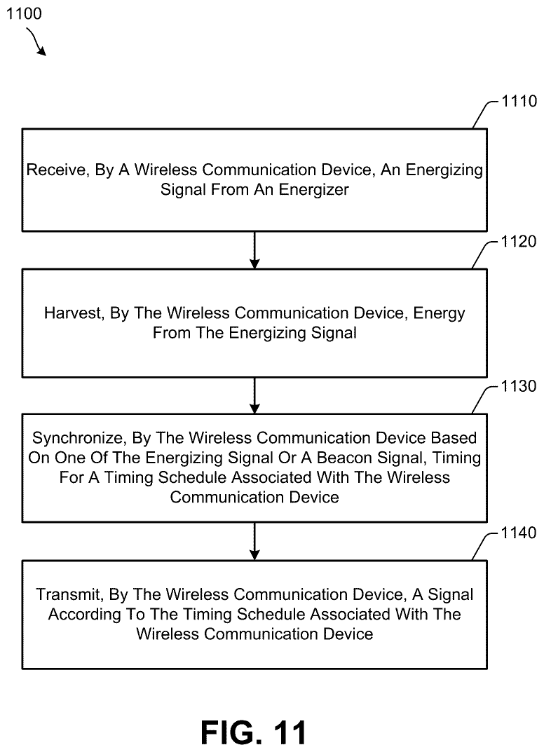

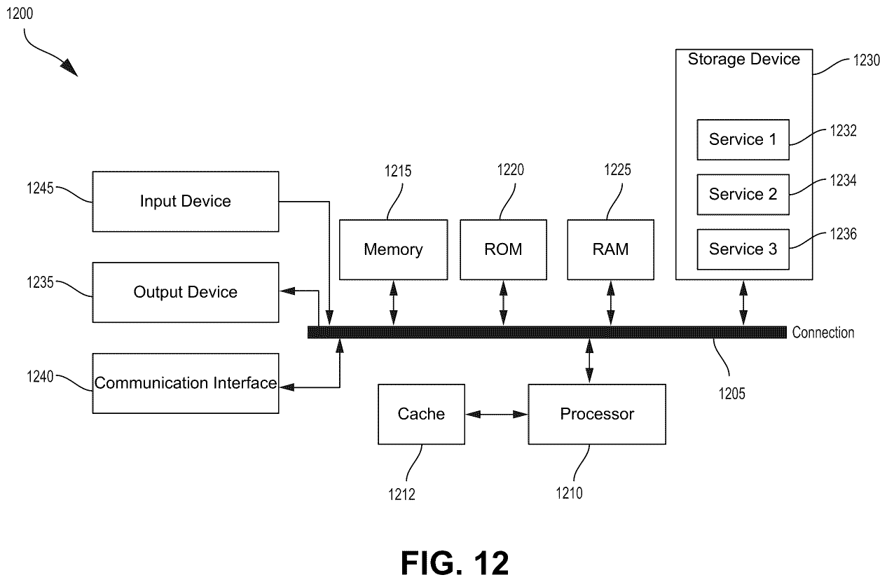

FIG. 11 is a flow chart illustrating an example of a process 1100 for wireless communications utilizing methods for batteryless wireless communication devices (e.g., RFEH devices, such as batteryless tags or labels) advertising using a PA. The process 1100 can be performed by a wireless communication device (e.g., the energy harvesting device 500 of FIG. 5, the tag 760 of FIG. 7, the tag issuing the tag signal 830 of FIG. 8, one of the tags 960a, 960b, or 960c of FIG. 9, one of the tags 1060a, 1060b, or 1060c of FIG. 10, etc., which in some cases can include an RFEH device, such as a batteryless tag or label) or by a component or system (e.g., a chipset) of the wireless communication device. The operations of the process 1100 may be implemented as software components that are executed and run on one or more processors (e.g., processor 1210 of FIG. 12 or other processor(s)). Further, the transmission and reception of signals by the wireless communications device in the process 1100 may be enabled, for example, by one or more antennas and/or one or more transceivers (e.g., wireless transceiver(s)).

At block 1110, the wireless communication device (or component thereof) can receive an energizing signal from an energizer (e.g., the energizer 730 of FIG. 7, the energizer 920 of FIG. 9, the energizer 1020 of FIG. 10, etc.).

At block 1120, the wireless communication device (or component thereof) can harvest energy from the energizing signal. In some cases, the wireless communication device (or component thereof) can harvest energy from one or more energy bursts of the energizing signal (e.g., energy bursts of the energy signal 850 shown in FIG. 8).

At block 1130, the wireless communication device (or component thereof) can synchronize, based on one of the energizing signal or a beacon signal, timing for a timing schedule associated with the wireless communication device. In some cases, the wireless communication device (or component thereof) can receive the beacon signal from an energy wireless communication device (e.g., the energy device 710, the ESL-e 720 of FIG. 7, the energizer 730 of FIG. 7, the ESL-e 930 of FIG. 9, the ESL-c 1030 of FIG. 10, the energizer 920 of FIG. 9, the energizer 1020 of FIG. 10, etc.).

In some aspects, the energizing signal includes one or more energy bursts, such as one or more energy bursts of the energizing signal (e.g., energy bursts of the energy signal 850 shown in FIG. 8). In such aspects, the wireless communication device (or component thereof) can synchronize the timing for the timing schedule based on a time of a boundary of an energy burst of the one or more energy bursts (e.g., boundary 925 of FIG. 9). In some aspects, the boundary is one of a start boundary or a stop boundary of the energy burst. In some aspects, the beacon signal includes one or more pulses (e.g., a pulse from an ESL-e beacon signal). In such aspects, the wireless communication device (or component thereof) can synchronize the timing for the timing schedule based on a time of a pulse of the one or more pulses of the beacon signal. For instance, referring to FIG. 10 as an illustrative example, tag 1 1060a can calculate that its response slot is a specific time delta (e.g., Δt1) after a time of reception 1035 of a pulse from the ESL-e beacon signal.

At block 1140, the wireless communication device (or component thereof) can transmit, by the wireless communication device, a signal according to the timing schedule associated with the wireless communication device. In some cases, the wireless communication device (or component thereof) can transmit the signal within a time slot of the timing schedule. For instance, a time of the time slot can be based on an identification (ID) of the wireless communication device and/or other information characteristic (e.g., unique information or characteristic) of the wireless communication device (e.g., to limit potential interference in communications). In some aspects, the wireless communication device (or component thereof) can transmit the signal when the wireless communication device is sufficiently energized by the energizing signal to perform transmission.

FIG. 12 is a block diagram illustrating an example of a computing system 1200, which may be employed by the disclosed systems and techniques for batteryless wireless communication devices (e.g., RFEH devices, such as batteryless tags or labels) advertising using a PA. In particular, FIG. 12 illustrates an example of computing system 1200, which can be, for example, any computing device making up internal computing system, a remote computing system, a camera, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some aspects, computing system 1200 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1200 includes at least one processing unit (CPU or processor) 1210 and connection 1205 that communicatively couples various system components including system memory 1215, such as read-only memory (ROM) 1220 and random access memory (RAM) 1225 to processor 1210. Computing system 1200 can include a cache 1212 of high-speed memory connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms. In some instances, multimodal systems can enable a user to provide multiple types of input/output to communicate with computing system 1200.

Computing system 1200 can include communications interface 1240, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1240 may also include one or more range sensors (e.g., LIDAR sensors, laser range finders, RF radars, ultrasonic sensors, and infrared (IR) sensors) configured to collect data and provide measurements to processor 1210, whereby processor 1210 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some aspects, a hardware service that performs a particular function can include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A wireless communication device, the wireless communication device comprising at least one processor configured to: receive an energizing signal from an energizer; harvest energy from the energizing signal; synchronize, based on one of the energizing signal or a beacon signal, timing for a timing schedule associated with the wireless communication device; and cause a signal to be transmitted according to the timing schedule associated with the wireless communication device.

Aspect 2. The wireless communication device of Aspect 1, wherein the wireless communication device is tag device.

Aspect 3. The wireless communication device of any one of Aspects 1 or 2, wherein the at least one processor is configured to receive the beacon signal from an energy wireless communication device.

Aspect 4. The wireless communication device of any one of Aspects 1 to 3, wherein the energizing signal comprises one or more energy bursts, and wherein the at least one processor is configured to synchronize the timing for the timing schedule based on a time of a boundary of an energy burst of the one or more energy bursts.

Aspect 5. The wireless communication device of Aspect 4, wherein the boundary is one of a start boundary or a stop boundary of the energy burst.

Aspect 6. The wireless communication device of any one of Aspects 1 to 5, wherein the beacon signal comprises one or more pulses, and wherein the at least one processor is configured to synchronize the timing for the timing schedule based on a time of a pulse of the one or more pulses of the beacon signal.

Aspect 7. The wireless communication device of any one of Aspects 1 to 6, wherein, to cause the signal to be transmitted according to the timing schedule, the at least one processor is configured to cause the signal to be transmitted within a time slot of the timing schedule.

Aspect 8. The wireless communication device of Aspect 7, wherein a time of the time slot is based on at least one of an identification (ID) or a characteristic of the wireless communication device.

Aspect 9. The wireless communication device of any one of Aspects 1 to 8, wherein, to harvest the energy from the energizing signal, the at least one processor is configured to harvest energy from one or more energy bursts of the energizing signal.

Aspect 10. The wireless communication device of any one of Aspects 1 to 9, wherein the at least one processor is configured to cause the signal to be transmitted when the wireless communication device is sufficiently energized by the energizing signal to perform transmission.

Aspect 11. A method of wireless communication performed at a wireless communication device, the method comprising: receiving, by the wireless communication device, an energizing signal from an energizer; harvesting, by the wireless communication device, energy from the energizing signal; synchronizing, by the wireless communication device based on one of the energizing signal or a beacon signal, timing for a timing schedule associated with the wireless communication device; and transmitting, by the wireless communication device, a signal according to the timing schedule associated with the wireless communication device.

Aspect 12. The method of Aspect 11, wherein the wireless communication device is a tag device.

Aspect 13. The method of any one of Aspects 11 or 12, further comprising receiving, by the wireless communication device from an energy wireless communication device, the beacon signal.

Aspect 14. The method of any one of Aspects 11 to 13, wherein the energizing signal comprises one or more energy bursts, and wherein synchronizing the timing for the timing schedule is based on a time of a boundary of an energy burst of the one or more energy bursts.

Aspect 15. The method of Aspect 14, wherein the boundary is one of a start boundary or a stop boundary of the energy burst.

Aspect 16. The method of any one of Aspects 11 to 15, wherein the beacon signal comprises one or more pulses, and wherein synchronizing the timing for the timing schedule is based on a time of a pulse of the one or more pulses of the beacon signal.

Aspect 17. The method of any one of Aspects 11 to 16, wherein transmitting the signal according to the timing schedule comprises transmitting the signal within a time slot of the timing schedule.

Aspect 18. The method of Aspect 17, wherein a time of the time slot is based on at least one of an identification (ID) or a characteristic of the wireless communication device.

Aspect 19. The method of any one of Aspects 11 to 18, wherein harvesting the energy from the energizing signal comprises harvesting energy from one or more energy bursts of the energizing signal.

Aspect 20. The method of any one of Aspects 11 to 19, further comprising transmitting the signal when the wireless communication device is sufficiently energized by the energizing signal to perform transmission.

Aspect 21. A non-transitory computer-readable storage medium of a wireless communication device comprising instructions stored thereon which, when executed by at least one processor, cause the at least one processor to perform operations according to any one of Aspects 11 to 20.

Aspect 22. An apparatus for wireless communications, comprising one or more means for performing operations according to any one of Aspects 11 to 20.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A wireless communication device, the wireless communication device comprising at least one processor configured to:
receive an energizing signal from an energizer;
harvest energy from the energizing signal;
synchronize, based on one of the energizing signal or a beacon signal, timing for a timing schedule associated with the wireless communication device; and
cause a signal to be transmitted according to the timing schedule associated with the wireless communication device.

2. The wireless communication device of claim 1, wherein the wireless communication device is a tag device.

3. The wireless communication device of claim 1, wherein the at least one processor is configured to receive the beacon signal from an energy wireless communication device.

4. The wireless communication device of claim 1, wherein the energizing signal comprises one or more energy bursts, and wherein the at least one processor is configured to synchronize the timing for the timing schedule based on a time of a boundary of an energy burst of the one or more energy bursts.

5. The wireless communication device of claim 4, wherein the boundary is one of a start boundary or a stop boundary of the energy burst.

6. The wireless communication device of claim 1, wherein the beacon signal comprises one or more pulses, and wherein the at least one processor is configured to synchronize the timing for the timing schedule based on a time of a pulse of the one or more pulses of the beacon signal.

7. The wireless communication device of claim 1, wherein, to cause the signal to be transmitted according to the timing schedule, the at least one processor is configured to cause the signal to be transmitted within a time slot of the timing schedule.

8. The wireless communication device of claim 7, wherein a time of the time slot is based on at least one of an identification (ID) or a characteristic of the wireless communication device.

9. The wireless communication device of claim 1, wherein, to harvest the energy from the energizing signal, the at least one processor is configured to harvest energy from one or more energy bursts of the energizing signal.

10. The wireless communication device of claim 1, wherein the at least one processor is configured to cause the signal to be transmitted when the wireless communication device is sufficiently energized by the energizing signal to perform transmission.

11. A method of wireless communication performed at a wireless communication device, the method comprising:
receiving, by the wireless communication device, an energizing signal from an energizer;
harvesting, by the wireless communication device, energy from the energizing signal;
synchronizing, by the wireless communication device based on one of the energizing signal or a beacon signal, timing for a timing schedule associated with the wireless communication device; and
transmitting, by the wireless communication device, a signal according to the timing schedule associated with the wireless communication device.

12. The method of claim 11, wherein the wireless communication device is a tag device.

13. The method of claim 11, further comprising receiving, by the wireless communication device from an energy wireless communication device, the beacon signal.

14. The method of claim 11, wherein the energizing signal comprises one or more energy bursts, and wherein synchronizing the timing for the timing schedule is based on a time of a boundary of an energy burst of the one or more energy bursts.

15. The method of claim 14, wherein the boundary is one of a start boundary or a stop boundary of the energy burst.

16. The method of claim 11, wherein the beacon signal comprises one or more pulses, and wherein synchronizing the timing for the timing schedule is based on a time of a pulse of the one or more pulses of the beacon signal.

17. The method of claim 11, wherein transmitting the signal according to the timing schedule comprises transmitting the signal within a time slot of the timing schedule.

18. The method of claim 17, wherein a time of the time slot is based on at least one of an identification (ID) or a characteristic of the wireless communication device.

19. The method of claim 11, wherein harvesting the energy from the energizing signal comprises harvesting energy from one or more energy bursts of the energizing signal.

20. The method of claim 11, further comprising transmitting the signal when the wireless communication device is sufficiently energized by the energizing signal to perform transmission.
